(19) United States
(12) Patent Application Publication
(10) Pub. No.: US 2006/0129434 A1
(43) Pub. Date: Jun. 15, 2006

(54) System and method for disseminating healthcare data from a database

(75) Inventors: Marlene Smitherman, Austin, TX (US); Robert Krueger, Austin, TX (US); Robert Hawkins, Austin, TX (US); Wayne Campbell, Austin, TX (US)

Correspondence Address: ANDERSON & JANSSON, L.L.P., 9501 N. CAPITAL OF TX HWY. #202, AUSTIN, TX, 78759, US

(73) Assignee: Critical Connection Inc., Austin, TX (US)

(21) Appl. No.: 11/300,704

(22) Filed: Dec. 15, 2005

Related U.S. Application Data
(60) Provisional application No. 60/636,295, filed on Dec. 15, 2004.

(51) Int. Cl. G06F 19/00

(52) U.S. Cl. 705/3

(57) ABSTRACT

A system and method for disseminating healthcare data in a database includes storing the healthcare data in the database located in a central server connected to a community of independent sources of the healthcare data for a plurality of patients; incorporating one or more updates to the healthcare data in the database from one or more of the independent sources to enable one or more healthcare providers, including rarely-used healthcare providers, to receive current data concerning the plurality of patients, the current data including demographic data on the plurality of patients; coding the healthcare data in the database to enable on-the-fly transmission of the healthcare data to one or more healthcare service providers outside the community of independent sources.

### CROSS-REFERENCE TO RELATED APPLICATIONS

This application is a non-provisional application claiming priority from provisional application Ser. No. 60/636,295, filed on Dec. 15, 2004, entitled “METHODS AND SYSTEMS FOR INFORMATION PROCESSING OF MEDICAL DATA,” the teachings of which are incorporated by reference herein as if reproduced in full below.

### FIELD OF INVENTION

The present disclosure relates generally to the field of healthcare data and to methods and systems for communicating healthcare data efficiently and securely including methods applicable to ensuring effective communication and to information processing systems, and, more particularly, to networked computing systems for capturing patient information, storing patient information, tagging electronic health data, preparing for disaster recovery, structuring a patient database, and establishing provider connectivity.

### BACKGROUND

The healthcare field generates huge amounts of information that must be collected and utilized effectively to deliver modern quality healthcare. Collecting and utilizing such a huge amount of information presents a serious problem with which industry participants have continually had to come to grips. Exacerbating the problem is the conflict between the well-known healthcare axiom that “healthcare is local,” the large number of independent healthcare providers who have a hand in caring for a given patient over time and whose care benefits from having timely access to information generated by other healthcare providers, and the tremendous increasing mobility of individuals, including both patients and healthcare professionals.

Accordingly, there is a strong need for solutions which improve and facilitate collection and utilization of healthcare information.

### SUMMARY

In one aspect, a method for disseminating healthcare data in a database includes storing the healthcare data in the database located in a central server connected to a community of independent sources of the healthcare data for a plurality of patients; incorporating one or more updates to the healthcare data in the database from one or more of the independent sources to enable one or more healthcare providers, including rarely-used healthcare providers, to receive current data concerning the plurality of patients, the current data including demographic data on the plurality of patients; and coding the healthcare data in the database to enable on-the-fly transmission of the healthcare data to one or more healthcare service providers outside the community of independent sources.

In another aspect, a computer program product can include a signal bearing medium bearing one or more instructions including, but not limited to one or more instructions for one or more instructions for one or more instructions for storing the healthcare data in the database located in a central server connected to a community of independent sources of the healthcare data for a plurality of patients; one or more instructions for incorporating one or more updates to the healthcare data in the database from one or more of the independent sources to enable one or more healthcare providers, including rarely-used healthcare providers, to receive current data concerning the plurality of patients, the current data including demographic data on the plurality of patients; and one or more instructions for coding the healthcare data in the database to enable on-the-fly transmission of the healthcare data to one or more healthcare service providers outside the community of independent sources; and In addition to the foregoing, other computer program product aspects are described in the claims, drawings, and text forming a part of the present application.

In one or more various aspects, related systems include but are not limited to circuitry and/or programming for effecting the herein-referenced method aspects; the circuitry and/or programming can be virtually any combination of hardware, software, and/or firmware configured to effect the herein-referenced method aspects depending upon the design choices of the system designer. In addition to the foregoing, other system aspects are described in the claims, drawings, and text forming a part of the present application.

In one aspect, a computer system includes but is not limited to a processor, a memory coupled to the processor, and a data store coupled to the processor, the data store configured to organize in a database the healthcare data from the community of independent sources, the database coded to enable on-the-fly transmission of the healthcare data to one or more healthcare service providers outside the community of independent sources; and a transceiver coupled to the processor, the transceiver configured to transmit a report based on the healthcare data in the database, the healthcare data including one or more updates from one or more of the independent sources to enable one or more healthcare providers, including rarely-used healthcare providers, to receive current data concerning a plurality of patients, the current data including demographic data on the plurality of patients.

In addition to the foregoing, other system aspects are described in the claims, drawings, and text forming a part of the present application.

In addition to the foregoing, various other method, system, and/or computer program product aspects are set forth and described in the text (e.g., claims and/or detailed description) and/or drawings of the present application. The foregoing is a summary and thus contains, by necessity, simplifications, generalizations and omissions of detail; consequently, those skilled in the art will appreciate that the summary is illustrative only and is NOT intended to be in any way limiting. Other aspects, features, and advantages of the devices and/or processes and/or other subject described herein will become apparent in the text set forth herein.

### BRIEF DESCRIPTION OF THE DRAWINGS

A better understanding of the subject matter of the application can be obtained when the following detailed description of the disclosed embodiments is considered in conjunction with the following drawings, in which:

FIG. 1 is a block diagram of an exemplary computer architecture that supports the claimed subject matter of the present application;

FIG. 2 is a block diagram of an exemplary electronic connectivity system in accordance with an embodiment of the present application;

FIG. 3 illustrates a flow diagram of a method in accordance with an embodiment of the subject matter of the present application;

FIG. 4 illustrates a flow diagram of a method in accordance with an embodiment of the subject matter of the present application;

FIG. 5 illustrates a flow diagram of a method in accordance with an embodiment of the subject matter of the present application;

FIG. 6 illustrates a flow diagram of a method in accordance with an embodiment of the subject matter of the present application;

FIGS. 7-26 illustrate screen shots of a graphical user interface that supports the claimed subject matter of the present application; and

FIG. 27 illustrates a “day sheet” in accordance with an embodiment of the subject matter of the present invention.

### DETAILED DESCRIPTION OF THE DRAWINGS

In the description that follows, the subject matter of the application will be described with reference to acts and symbolic representations of operations that are performed by one or more computers, unless indicated otherwise. As such, it will be understood that such acts and operations, which are at times referred to as being computer-executed, include the manipulation by the processing unit of the computer of electrical signals representing data in a structured form. This manipulation transforms the data or maintains it at locations in the memory system of the computer which reconfigures or otherwise alters the operation of the computer in a manner well understood by those skilled in the art. The data structures where data is maintained are physical locations of the memory that have particular properties defined by the format of the data. However, although the subject matter of the application is being described in the foregoing context, it is not meant to be limiting as those of skill in the art will appreciate that some of the acts and operations described hereinafter can also be implemented in hardware, software, and/or firmware and/or some combination thereof.

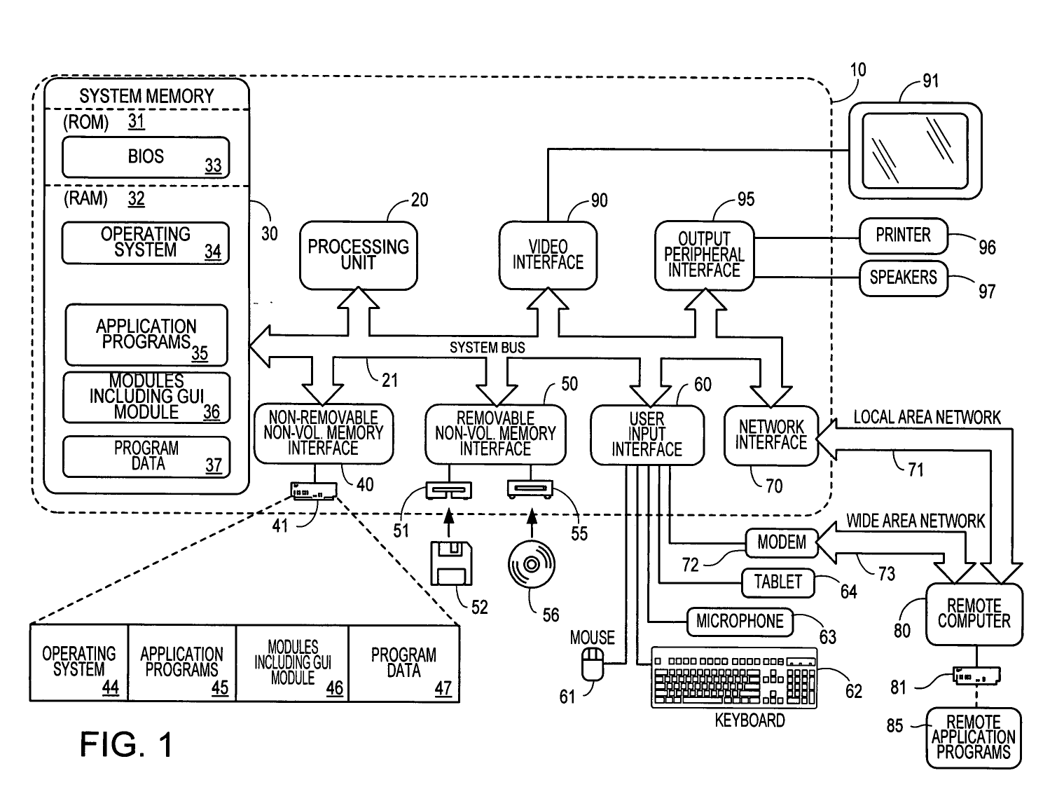

With reference to FIG. 1, an exemplary computing system for implementing the embodiments and includes a general purpose computing device in the form of a computer 10. Components of the computer 10 may include, but are not limited to, a processing unit 20, a system memory 30, and a system bus 21 that couples various system components including the system memory to the processing unit 20. The system bus 21 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 10 typically includes a variety of computer readable media. Computer readable media can be any available media that can be accessed by the computer 10 and includes both volatile and nonvolatile media, and removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computer 10. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 30 includes computer storage media in the form of volatile and/or nonvolatile memory such as read only memory (ROM) 31 and random access memory (RAM) 32. A basic input/output system 33 (BIOS), containing the basic routines that help to transfer information between elements within computer 10, such as during start-up, is typically stored in ROM 31. RAM 32 typically contains data and/or program modules that are immediately accessible to and/or presently being operated on by processing unit 20. By way of example, and not limitation, FIG. 1 illustrates operating system 34, application programs 35, other program modules 36 and program data 37. FIG. 1 is shown with program modules 36 including a application module in accordance with an embodiment as described herein.

The computer 10 may also include other removable/non-removable, volatile/nonvolatile computer storage media. By way of example only, FIG. 1 illustrates a hard disk drive 41 that reads from or writes to non-removable, nonvolatile magnetic media, a magnetic disk drive 51 that reads from or writes to a removable, nonvolatile magnetic disk 52, and an optical disk drive 55 that reads from or writes to a removable, nonvolatile optical disk 56 such as a CD ROM or other optical media. Other removable/non removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 41 is typically connected to the system bus 21 through a non-removable memory interface such as interface 40, and magnetic disk drive 51 and optical disk drive 55 are typically connected to the system bus 21 by a removable memory interface, such as interface 50.

The drives and their associated computer storage media, discussed above and illustrated in FIG. 1, provide storage of computer readable instructions, data structures, program modules and other data for the computer 10. In FIG. 1, for example, hard disk drive 41 is illustrated as storing operating system 44, application programs 45, other program modules 46 and program data 47. Program modules 46 can be configured as either located in modules 36 or 46, or both locations, as one with skill in the art will appreciate. Note that these components can either be the same as or different from operating system 34, application programs 35, other program modules 36, and program data 37. Operating system 44, application programs 45, other program modules 46, and program data 47 are given different numbers hereto illustrate that, at a minimum, they are different copies. A user may enter commands and information into the computer 10 through input devices such as a tablet, or electronic digitizer, 64, a microphone 63, a keyboard 62 and pointing device 61, commonly referred to as a mouse, trackball or touch pad. Other input devices (not shown) may include a joystick, game pad, satellite dish, scanner, or the like. These and other input devices are often connected to the processing unit 20 through a user input interface 60 that is coupled to the system bus, but may be connected by other interface and bus structures, such as a parallel port, game port or a universal serial bus (USB). A monitor 91 or other type of display device is also connected to the system bus 21 via an interface, such as a video interface 90. The monitor 91 may also be integrated with a touch-screen panel or the like. Note that the monitor and/or touch screen panel can be physically coupled to a housing in which the computing device 10 is incorporated, such as in a tablet-type personal computer. In addition, computers such as the computing device 10 may also include other peripheral output devices such as speakers 97 and printer 96, which may be connected through an output peripheral interface 94 or the like.

The computer 10 may operate in a networked environment using logical connections to one or more remote computers, such as a remote computer 80. The remote computer 80 may be a personal computer, a server, a router, a network PC, a peer device or other common network node, and typically includes many or all of the elements described above relative to the computer 10, although only a memory storage device 81 has been illustrated in FIG. 1. The logical connections depicted in FIG. 1 include a local area network (LAN) 71 and a wide area network (WAN) 73, but may also include other networks. Such networking environments are commonplace in offices, enterprise-wide computer networks, intranets and the Internet. For example, in the present invention, the computer system 10 may comprise the source machine from which data is being migrated, and the remote computer 80 may comprise the destination machine. Note however that source and destination machines need not be connected by a network or any other means, but instead, data may be migrated via any media capable of being written by the source platform and read by the destination platform or platforms.

When used in a LAN or WLAN networking environment, the computer 10 is connected to the LAN through a network interface or adapter 70. When used in a WAN networking environment, the computer 10 typically includes a modem 72 or other means for establishing communications over the WAN 73, such as the Internet. The modem 72, which may be internal or external, may be connected to the system bus 21 via the user input interface 60 or other appropriate mechanism. In a networked environment, program modules depicted relative to the computer 10, or portions thereof, may be stored in the remote memory storage device. By way of example, and not limitation, FIG. 1 illustrates remote application programs 85 as residing on memory device 81. It will be appreciated that the network connections shown are exemplary and other means of establishing a communications link between the computers may be used.

In the description that follows, the invention will be described with reference to acts and symbolic representations of operations that are performed by one or more computers, unless indicated otherwise. As such, it will be understood that such acts and operations, which are at times referred to as being computer-executed, include the manipulation by the processing unit of the computer of electrical signals representing data in a structured form. This manipulation transforms the data or maintains it at locations in the memory system of the computer which reconfigures or otherwise alters the operation of the computer in a manner well understood by those skilled in the art. The data structures where data is maintained are physical locations of the memory that have particular properties defined by the format of the data. However, although the invention is being described in the foregoing context, it is not meant to be limiting as those of skill in the art will appreciate that some of the acts and operation described hereinafter can also be implemented in hardware.

The claimed subject matter can be implemented in any information technology (IT) system in which automated networked distribution of information is desirable. Those with skill in the computing arts will recognize that the disclosed embodiments have relevance to a wide variety of computing environments in addition to those described below. In addition, the methods of the disclosed invention can be implemented in software, hardware, or a combination of software and hardware. For example, the hardware portion can be implemented using specialized logic; by way of further example, the software portion can be stored in a memory and executed by a suitable instruction execution system such as a microprocessor, personal computer (PC), or mainframe.

In the context of this document, a “computer-readable medium” can be any means that contains, stores, communicates, propagates, or transports a program and/or data for use by or in conjunction with an instruction execution system, apparatus, or device. In the context of this document, a “memory” is a type of computer-readable medium, and can be, but is not limited to, an electronic, magnetic, optical, electromagnetic, infrared, or semiconductor system, apparatus, or device. Memory also includes, but is not limited to, for example, the following: a portable computer diskette, a random access memory (RAM), a read-only memory (ROM), an erasable programmable read-only memory (EPROM or flash memory), and a portable compact disk read-only memory. In the context of this document, a “signal” is a type of computer-readable medium, and can be, but is not limited to, an electrical, optical, or acoustical signal, signals embodied in a carrier wave, or any other manufactured transient phenomenon in which a program and/or data can be encoded.

Various embodiments described herein apply computer systems and methods to healthcare solutions that require computer and/or network connectivity. There are estimates that 30% of U.S. healthcare expenditures are misspent on inefficient or ineffective care. The annual healthcare and productivity cost per employee for inefficient and ineffective care amounts to approximately $2000 per employee. The U.S. Health and Human Services Department estimates that the lack of connectivity among those in the healthcare industry costs the United States over $100 billion annually. Additionally, the lack of connectivity among those involved in healthcare has caused healthcare errors that contribute to the over 98,000 avoidable deaths that occur in U.S. hospitals each year.

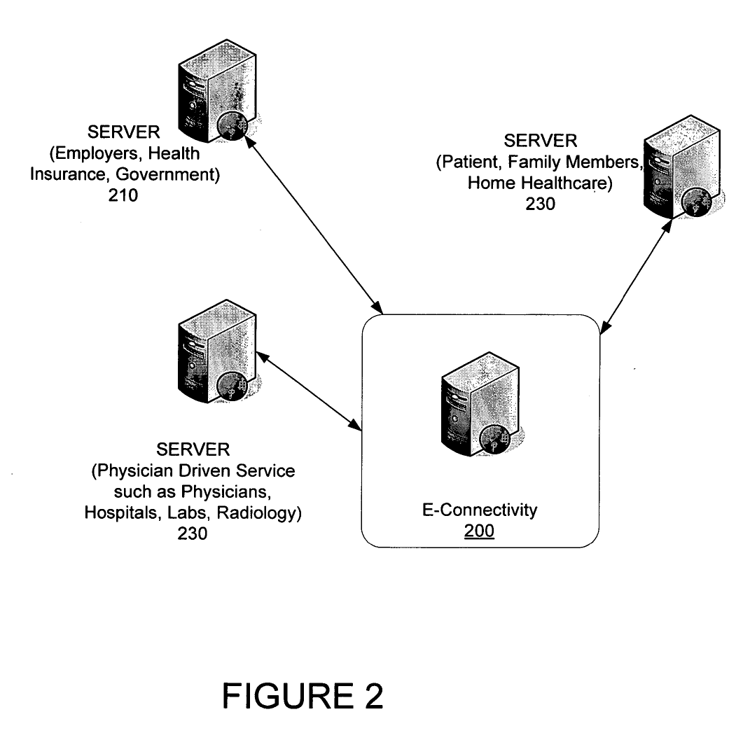

Referring to FIG. 2, the methods and systems provided herein address the issues and costs surrounding the lack of connectivity, in the healthcare industry by using what is referred to as electronic connectivity, “e-connectivity” 200. Thereby connecting payers of care 210, including employers, health insurance, and governmental entities, patients 220, which could include family members and home health care contractors, and physician-driven services 230, including physicians, hospitals, labs and radiology entities. The combination of the entities that make up the healthcare industry is referred to herein as a community of independent healthcare data participants.

Embodiments described herein include methods and systems for capturing patient information, storing patient information, tagging electronic health data, preparing for disaster recovery, structuring a patient database, and establishing provider connectivity. The methods disclosed herein can be implemented in logic stored on a computer-readable medium (e.g., memory, signal, etc.).

To implement embodiments, a universal patient record (UPR) is described herein for capturing patient information. A UPR can be created after a patient is registered in a patient database by entering a variety of demographic information and signing a consent to be part of the database. A universal patient record associated with the patient is populated in the patient database. The correct completion of legally-required healthcare documentation is verified. If the documentation includes a patient consent form and a healthcare provider is identified in the patient consent form, the universal patient record can be linked to the healthcare provider. If the documentation includes a withdrawal form and the healthcare provider is identified in the patient consent form, the healthcare provider is de-linked from future universal patient records.

In one embodiment, electronic health data for a patient, including an initial format, is committed to custodial care. The electronic health data is converted from the initial format to a retention format and referred to as the universal patient record (UPR). A UPR can be defined as an electronic health record that aggregates healthcare data from multiple treating physicians, ancillary providers and other healthcare providers to provide a comprehensive view of the patient in standardized formats. The UPR is retained in the retention format. The UPR can be stored in the retention format and copied and stored in multiple storage devices. When restored, the UPR can be restored to a previously known state of correct content when requested. In one embodiment, the UPR includes an electronic data interface populated with the formatted healthcare data, the universal patient record applying the formatted healthcare data to include at least one of a summary of patient information, current medications, demographic data, vital data, insurance data, pharmacy data, identification of a primary care physician and current healthcare issues.

The UPR can include tagged electronic health data. Whether the electronic health data conforms to a set of externally defined rules is determined. If the electronic health data conforms to a set of externally defined rules, tags are applied to selected elements of the electronic health data, and the tags are linked to corresponding items in a patient database. As a result, the tagged and linked electronic health data becomes a UPR to be recorded in a patient database.

The UPR can be copied and stored in multiple and redundant storage devices so that the UPR can be restored to a previously known state of correct content when requested. At selected time intervals, the integrity of the data storage is checked, in that a copy of the UPR is retrieved from each of the storage devices, and each retrieved copy of the UPR is compared to a known true copy of the UPR to determine the accuracy of each retrieved copy.

A set of UPRs corresponding to one or more patients can be recorded in a host database. Each UPR of the set of UPRs can include one or more of healthcare history, healthcare encounters, family history, healthcare images, and laboratory results. Access to the set of UPRs is presented upon verification of sufficient credentials and authority of a user. In one embodiment, a copy of a subset of the set is stored on a point-of-service database. The subset includes those UPRs of the set of UPRs identified as recently active. If a query to the point-of-service database specifies a UPR not contained within the subset, the query can be redirected to the host database, for example, a host database located in a central server. If the UPR is contained within the set, the UPR is copied to the point-of-service database, and the UPR is added to the subset. Changes to the subset of UPRs on the point-of-service database are replicated to the set of UPRs on the host database. If an instruction to the host database specifies deletion of an UPR, the UPR is retained. In the point-of-service database and in the host database, (i) the UPRs are maintained in a plurality of parts including a portion corresponding to traditional field, record, and file relationships corresponding to a relational database model, and a tag associated with certain fields, and (ii) the plurality of parts are joined upon retrieval and before transport.

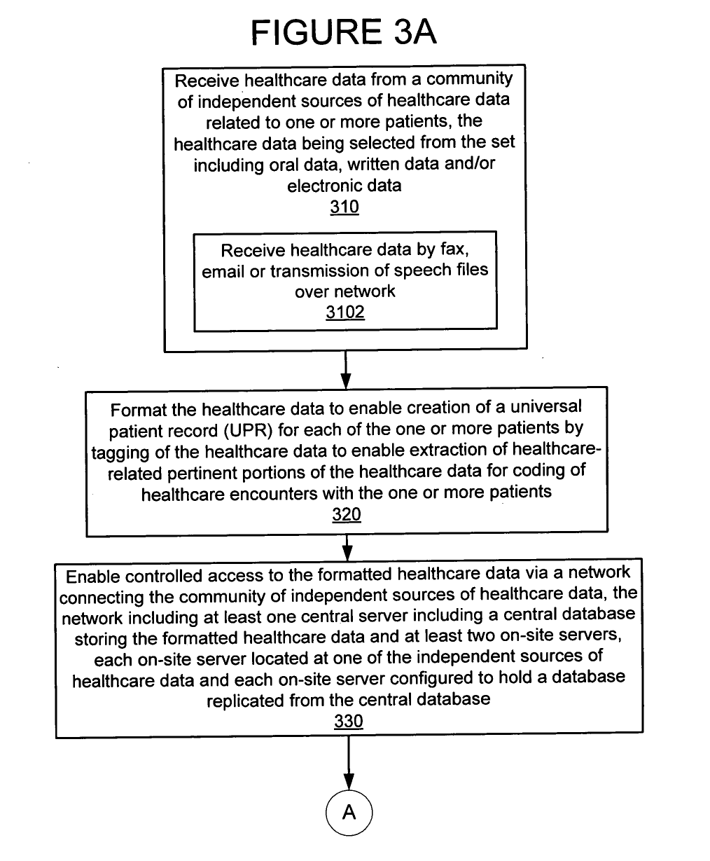

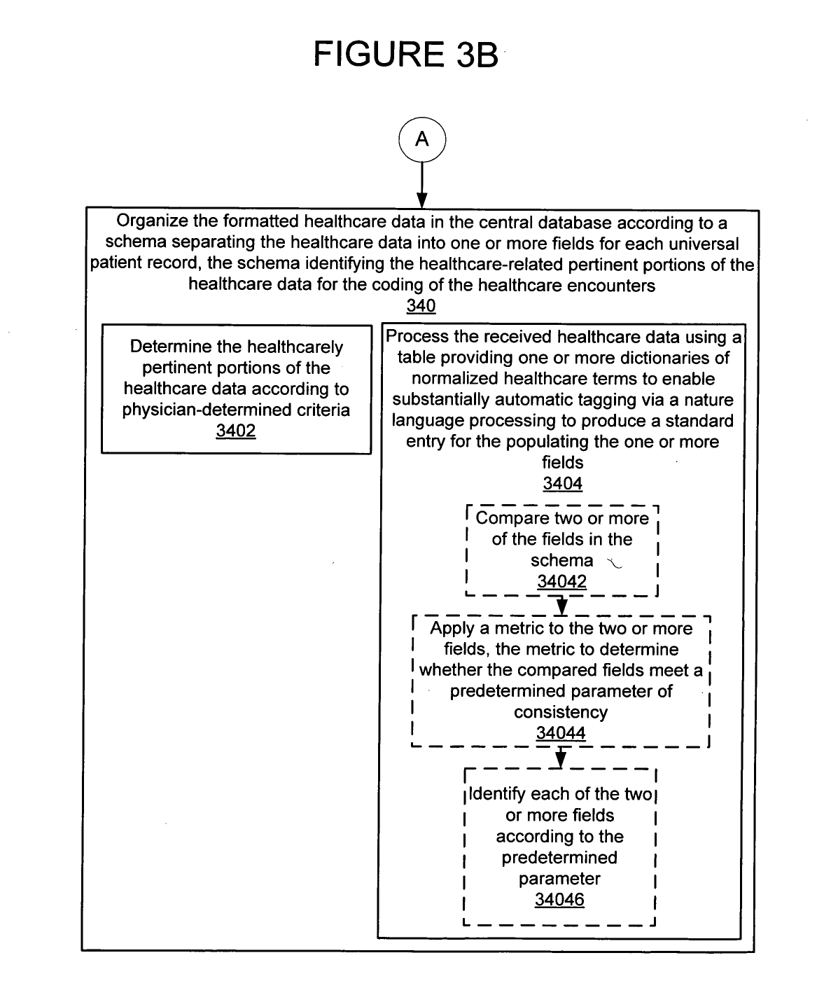

Referring now to FIG. 3, an embodiment is directed to a method for establishing provider connectivity by providing community healthcare data services. A community according to one embodiment can include a community served by a same central server. Alternatively, a community can be a set of servers each responsible for a portion of a database for a larger region and holding a distributed database wherein no single server breakdown should affect the ability of any other server to access a complete database. One method of insuring the complete database is available is to distribute the database among different servers and provide that concurrent copies are located in different servers. A distributed server system can assist in enlarging the definition of community to include not just a city or region of a state, but include areas of a country, or an entire country, continent or the like as limited only by the ability of the distributed server system to provide reliable service. Block 310 provides for receiving healthcare data from a community of independent sources of healthcare data related to one or more patients, the healthcare data being selected from the set including oral data, written data and/or electronic data. More specifically, the healthcare data received can be from the healthcare data information participants for entry into the patient database. Healthcare data received can then be formatted for entry into the database automatically or manually.

Depicted within Block 310 is block 3102 which provides for receiving the healthcare data by one or more of facsimile transmission, email transmission, and transmission of speech files over a network connection. More particularly, according to an embodiment, healthcare data can be received for transcription services and formatting for entry into the database via a number of modes so that automatic or manual formatting can take place. After formatting, the extraction of medically pertinent portions of the healthcare data can be accomplished via flagging a field in the universal patient record indicating a need for resolution of the inconsistency. In one embodiment, the flagging can be configured to provide a field indicative of whether the one or more patients are receiving compatible care from the one or more independent sources of healthcare data. The compatible care can include prescription compatibility, treatment compatibility, whether a patient is being treated for similar issues by different health care providers and the like.

Block 320 provides for formatting the healthcare data to enable creation of a universal patient record (UPR) for each of the one or more patients by tagging of the healthcare data to enable extraction of medically pertinent portions of the healthcare data for coding of healthcare encounters with the one or more patients. The coding can be for more or less than healthcare encounters and can include a plethora of healthcare data participant data including billing, insurance, and the like. The coding of healthcare encounters can enable linking via the tagging process using XML tags or the like as described herein.

Block 330 provides for enabling controlled access to the formatted healthcare data via a network connecting the community of independent sources of healthcare data, the network including at least one central server including a central database storing the formatted healthcare data and at least two on-site servers, each on-site server located at one of the independent sources of healthcare data and each on-site server configured to hold a database replicated from the central database. More specifically, after a database holds the coded healthcare data from encounters, the database can be replicated or made available from a central database serving a community of healthcare data participants via on-site servers described herein as point-of-service servers. In one embodiment, the on-site server can be located within an entity with several client machines coupled to the on-site server, such as, for example, a clinic setting with a plurality of physicians or specialists or the like. In another embodiment the controlled access includes providing cryptographic access to the formatted healthcare data. For example, as described herein, cryptographic access via Department of Defense standards or the like.

Block 340 provides for organizing the formatted healthcare data in the central database according to a schema separating the healthcare data into one or more fields for each universal patient record, the schema identifying the medically pertinent portions of the healthcare data for the coding of the healthcare encounters. The organizing the formatted healthcare data in the central database according to a schema separating the healthcare data into one or more fields for each universal patient record, the schema identifying the medically pertinent portions of the healthcare data for the coding of the healthcare encounters can include providing in the schema that tagging in the healthcare encounters includes tagging a prognosis and/or a diagnosis, and providing a source for one or more history fields and/or one or more summary fields. Thus, the schema can take into account multiple levels of access of the healthcare data such that links caused by the tagging enable a user to locate all relevant healthcare data for a given issue.

Disposed within block 340 is block 3402, which provides that, optionally, the organizing the formatted healthcare data in the central database according to a schema includes determining the medically pertinent portions of the healthcare data according to physician-determined criteria. Further depicted within block 340 is block 3404 which provides that the organizing the formatted healthcare data in the central database according to a schema separating the healthcare data into one or more fields for each universal patient record, the schema identifying the medically pertinent portions of the healthcare data for the coding of the healthcare encounters includes processing the received healthcare data using a table providing one or more dictionaries of normalized healthcare terms to enable substantially automatic tagging via a natural language processing to produce a standard entry for the populating the one or more fields. In one embodiment, the processing the received healthcare data can, using a table providing one or more dictionaries of normalized healthcare terms to enable substantially automatic tagging via a natural language processing, produce a standard entry for the populating the one or more fields. For example, applying the dictionary of normalized terms can enable a standard entry for same and/or similar received healthcare data via parsing the healthcare data to locate relevant healthcare data.

The block 3404 schema separating the healthcare data into one or more fields for each universal patient record, can be configured to populate one or more fields in the schema with the healthcare data from the community of independent sources of healthcare data, such as physicians, insurance providers, home health care providers, dental providers, laboratories, pharmacies, healthcare image providers, and physical therapy providers and the like. To populate the fields, the medically pertinent portions of the healthcare data can be determined by locating one or more inconsistencies in the healthcare data received from the independent sources of healthcare data, the inconsistencies identifying potential health care issues for a patient. To identify the inconsistencies identifying potential health care issues for a patient, depicted within block 3404, a method is depicted. Block 34042 provides for comparing two or more of the fields in the schema. Block 34044 provides for applying a metric to the two or more fields, the metric to determine whether the compared fields meet a predetermined parameter of consistency. Block 34046 provides for identifying each of the two or more fields according to the predetermined parameter.

One method of determining whether inconsistencies are present in healthcare data includes determining a most recently altered field among the one or more inconsistencies in the healthcare data and tagging the most recently altered field. The tagging the most recently altered field enables a user of the database via a graphical user interface to quickly locate altered fields that present the inconsistency and locate each instance of an inconsistency. Also, the tagging can include providing a warning to a user of a universal patient record created using the database of the inconsistency. In one embodiment, the inconsistencies identifying potential health care issues for a patient can include prescription drug inconsistencies indicative of drug interactions; treatment inconsistencies; and inconsistencies in demographic data.

In one embodiment, the methods described in FIG. 3 are enabled via a module disposed within a computer system, such as computer system 100. Implementing the method in computer system 100 can include providing that a module coupled to the processor, such as module 160 and/or 170 are configured to incorporate healthcare data records, module configured to receive healthcare data from a community of independent sources of healthcare data related to one or more patients, the healthcare data being oral data, written data and/or electronic data. Module 160 and/or 170 can be configured to automatically format the healthcare data to enable creation of a universal patient record for each of the one or more patients, the formatting including tagging of the healthcare data to enable extraction of medically pertinent portions of the healthcare data for coding of healthcare encounters with the one or more patients; and enable controlled access to the formatted healthcare data via a network connecting the community of independent sources of healthcare data, the network including at least one central server including a central database of the formatted healthcare data and at least two on-site servers, each on-site server located at one of the independent sources of healthcare data and each on-site server configured to hold a database replicated from the central database.

### Data Entry

Whether the number of UPRs stored in a point-of-service database exceeds a selected threshold is determined. In one embodiment, a point-of-service database is hosted on two servers having fast-failover capability. If the threshold is exceeded, a set of UPRs contained within the point-of-service database is selected for long-term storage based on recent activity associated with each UPR, and each of the set of UPRs is moved from the point-of-service database to the long-term storage database by copying the UPR to the long-term storage database, confirming successful copying of the UPR to the long-term storage database, and deleting the UPR from the point-of-service database.

Data entry is the process that supports registering patients in a Patient Database by entering a variety of demographic information from either questionnaires or Registration forms; populates the UPR from questionnaires and Registration forms; verifies the correct completion of the Patient Consent/Withdrawal forms; links the patient's UPR to the appropriate health care providers as identified on the Patient Consent form; delinks the appropriate health care provider from the patient's future UPR data upon execution of the Patient Consent/Withdrawal form.

The Registration Tool can be configured to support both Pre-Registration and Registration by capturing basic demographic information, preparing the information for entry into the Patient Database and generating an internal, unique patient ID such as that based on a 128-bit GUID implementation.

The Data Entry Tool can be configured to support the functions of the Registration Tool as well as provide the capability for data entry.

The Data Entry Tool can be configured to provide for capturing the full set of data, preparing it for entry into the Patient Database and generating an internal, unique patient ID based on a 128-bit GUID implementation.

Data from the various forms is entered into one of two templates known collectively as the Data Entry Tools. These tools contain embedded XML codes used for formatting and data interchange within the Patient Database. The Data Entry Tools feed a post-processor that performs basic data analysis from a set of external rules, a rudimentary level of quality assurance and provides the XML tagging. These rules are provided by Data Entry personnel and consist of form and function identifiers that ensure completeness and accuracy of the data being entered. Questionaires and Patient Consent/Withdrawal forms are rejected as defective if they fail to meet the basic rules.

The Data Entry tool can provide for immediate encryption of all entered data at the close of the data entry cycle. Patient records can be loaded after they have been successfully encrypted at a (minimum) TripleDES/DES+ level of encryption. Records sent are archived through facilities meeting rules established by HIPAA for all health care information. No data is transferred within the system nor exchanged with outside systems unless it has been encrypted.

Periodic Audits are done by comparing randomly chosen data entry forms with their respective electronically generated equivalents.

Internal measures to insure data entry is done appropriately include cycle time measures. Cycle Time can be defined as the total time from when a change is requested until the change is made, tested and integrated into the production tool.

External measures to insure data entry is done appropriately include tools design, function and operation checks that determine if the tools allow for the optimization of Data Entry clerk productivity.

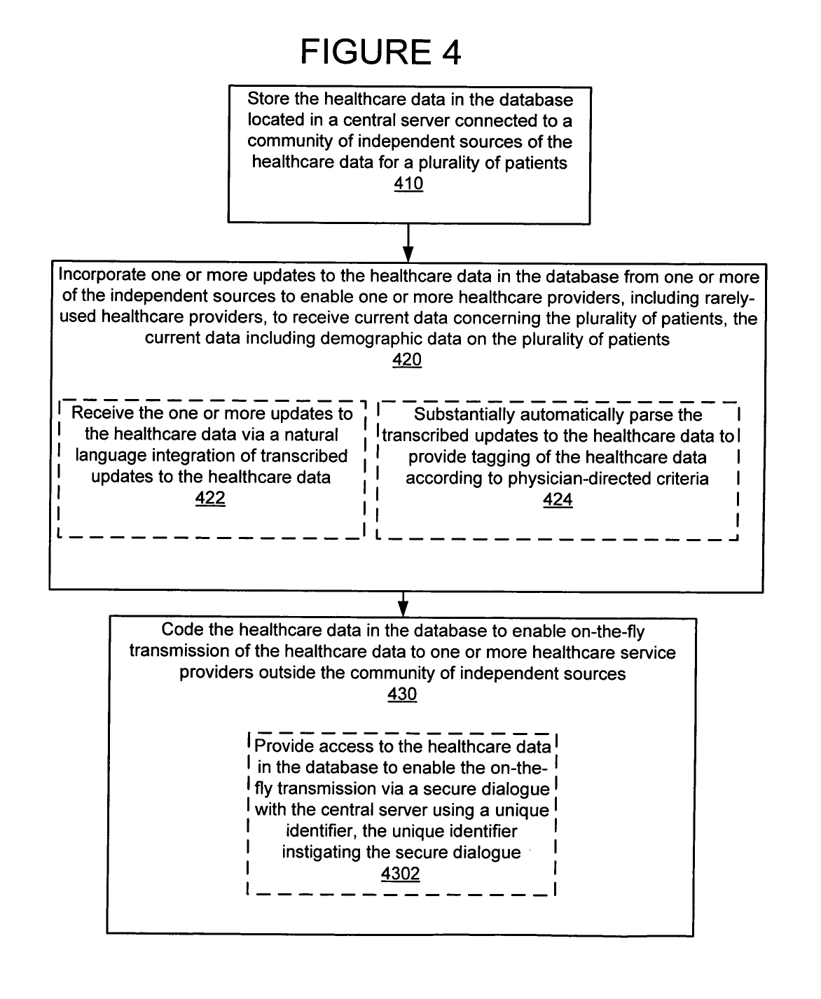

Following the data entry, healthcare data stored in the database can be disseminated. Referring to FIG. 4, a flow diagram illustrates a method for disseminating the healthcare data in a database, including the actions of Data Entry when updates are received and how the updates are disseminated to the community of independent sources of healthcare data and those outside the community of independent sources of healthcare data. In this regard, the community of independent sources can be considered within a region. Those participating in a service connected to a database could be interested in healthcare data stored in another region served by a different server. For example, a different region could hold a same database storing healthcare data for a different community of independent sources of healthcare data. Thus, if a patient travels, moves or otherwise needs to see a specialist connected to a different region, regardless of location, the specialist will have access to the same records as the patient's primary care physician. Likewise, if a patient needs to fill a prescription at a location outside of a given region, the patient will not be restricted as to choice of pharmacy because any pharmacy in a region served by the service will have access to the same prescriptions and data concerning whether or not the prescription has been filled.

Block 410 provides for storing the healthcare data in the database located in a central server connected to a community of independent sources of the healthcare data for a plurality of patients. The community can include all independent sources that are within a region served by a network of servers regularly disseminating a same database and/or portion of the same database. The central server can be one of a plurality of regional servers connecting a plurality of communities of independent sources of healthcare data.

Block 420 provides for incorporating one or more updates to the healthcare data in the database from one or more of the independent sources to enable one or more healthcare providers, including rarely-used healthcare providers, to receive current data concerning the plurality of patients, the current data including demographic data on the plurality of patients. For example, within the region, after a UPR is configured, patients can move locations, alter insurance information or develop additional data for the healthcare data. In one embodiment, the updates can enable one of the one or more rarely-used healthcare providers to receive the one or more updates to the healthcare data via any of the plurality of regional servers. When a patient provides the information to a physician or other independent source of healthcare data, the data can be provided in any of the methods described herein to be transcribed and/or formatted for entry into the database and made available via appropriate permissions and the like to other independent sources of healthcare data. More particularly, depicted within block 420 are optional blocks 422 and 424. Block 422 provides for receiving the one or more updates to the healthcare data via a natural language integration of transcribed updates to the healthcare data. In one embodiment, the receiving the one or more updates can include receiving oral healthcare data from the one or more healthcare providers, the oral data received at the central server for transcribing via natural language processing to determine which of the healthcare data should be tagged according to the physician-directed criteria

Block 424 provides for substantially automatically parsing the transcribed updates to the healthcare data to provide tagging of the healthcare data according to physician-directed criteria. In one embodiment, the updates are received for tagging by the system and the tagging can be automatic.

Block 430 provides for coding the healthcare data in the database to enable on-the-fly transmission of the healthcare data to one or more healthcare service providers outside the community of independent sources. Depicted within block 430 is optional block 4302, which provides that the coding can include providing access to the healthcare data in the database to enable the on-the-fly transmission via a secure dialogue with the central server using a unique identifier, the unique identifier instigating the secure dialogue. In one embodiment, the on-the-fly transmission is received as a report from the central server, the report based on a universal patient record stored in the database. In one embodiment, the universal patient record is configured as an electronic data interface populated with tagged healthcare data, the universal patient record configured with tagged healthcare data to enable linking of healthcare data between a summary of patient information, a listing of current medications, the demographic data, vital data, insurance data, pharmacy data, identification of a primary care physician and current healthcare issues. The universal patient record is described in more detail above.

The report of healthcare data available for on-the-fly transmission is a reduced database of healthcare data, the reduced database of healthcare data including one or more of the demographic data, allergy data, laboratory reports, medications, current condition data and current healthcare issue data. Further the report can be in the form of a written and/or oral transmission from the central server to a predetermined location, the predetermined location being one or more of a client machine, a facsimile machine, and a telephone.

In one embodiment, the methods described in FIG. 4 are configured to be implemented in a computer system, such as computer system 100. More particularly, in an embodiment, computer system 100 is connected via a network connection to a community of independent sources of healthcare data and configured to hold a data store coupled to a processor. The data store can be configured to organize in the patient database of healthcare data from the community of independent sources and coded to enable on-the-fly transmission of the healthcare data to one or more healthcare service providers outside the community of independent sources. The computer system can further be configured with a transceiver coupled to the processor. The transceiver can be configured to transmit a report based on the healthcare data in the database. The healthcare data can include one or more updates from the independent sources to enable one or more healthcare providers, including rarely-used healthcare providers, to receive current data concerning a plurality of patients, the current data including demographic data on the plurality of patients.

### Storage and Backup

Storage and Backup are the processes whereby captured patient demographic data and associated UPRs are retained in perpetuity as an electronic image which is an exact replica of the original document, regardless of its input methodology and copied and stored in multiple sets of media so that system operations can be restored to a previously known checkpoint of correct operation when requested.

Hardcopy documents can be scanned, indexed and placed into storage as electronic images. In one embodiment, disposition of hardcopy documents is the sole responsibility of the requestor of these services. All storage and backup systems can be configured to ensure, at a minimum, a single level of redundancy. Backup may be on either locally or remotely available, permanently writeable media but can provide for easy accessibility and rapid access. Storage can be remote, i.e. located away from the requester, requiring a longer term accessibility and thus requiring a specified lead time within which to respond to requests for data.

The Storage & Backup process can be configured to provide all technology and capacity required for storing and archiving all information. All data can remain encrypted while in permanent storage archives in electronic form. In one embodiment, data transported between systems is encrypted at a Department of Defense (DOD)-level during any and all transactions which require movement of the data between or within the systems.

In one embodiment, requests for data storage, backup or retrieval are made to follow agreed-to response criteria, with no data loss being acceptable.

Broadband IP connectivity can be used for routing documents if of sufficient bandwidth to handle both current and expected volumes. The system can be configured to require a server of sufficient capacity to meet and maintain expected volumes with no degradation in performance with a firewall.

To ensure that the storage and backup process meet internal measures, the speed of compression/decompression algorithms, the speed of data access to/from storage and backup facilities, the cost per byte of storage media can be monitored. Moreover, the system can be configured such that no information can be misplaced by the system or fail to be retrieved on behalf of the requestor.

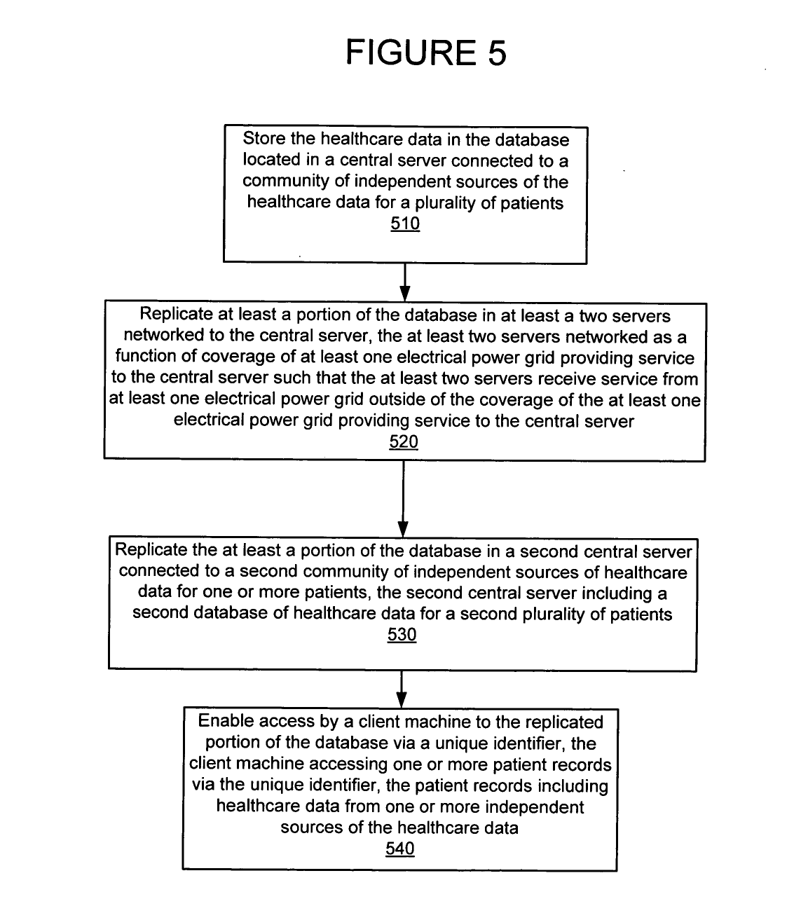

Referring now to FIG. 5, a flow diagram illustrates a method for restoring healthcare data stored in a database. Block 510 provides for storing the healthcare data in a database located in a central server connected to a community of independent sources of the healthcare data for a first plurality of patients.

Block 520 provides for replicating at least a portion of the database in at least two servers networked to the central server, the at least two servers networked as a function of coverage of at least one electrical power grid providing service to the central server such that the at least two servers receive service from at least one electrical power grid outside of the coverage of the at least one electrical power grid providing service to the central server. The replicating at least a portion of the database can include distributing the database to provide that the at least two servers are configured to store alternate portions of the database of healthcare data. For example, the database can be broken into portions so that the database for restoration purposes is distributed among several servers in different regions that are served by different electrical grids. In an embodiment, the alternate portions of the database may be stored by alternating which of the at least two servers receive predetermined portions of the database. Alternating the servers that store the portions of the database can assist in securely configuring a distributed system by ensuring that the data stored is a recent replication of a database or portion thereof. Moreover, if a previous alternate portion is stored on the server, the previous portion can be aggressively compressed or deleted.

In one embodiment, the central server can be connected via a network connection to a plurality of servers within a region defining a community of independent healthcare data participants, each of the plurality of servers receiving a replicated version of the database of healthcare data stored on the central server. Each of the plurality of servers can be configured to enable access to one or more of the independent healthcare data participants to the healthcare data stored on the central server. In one embodiment, the region may be defined according to the number of different internet service providers available to transfer data. Thus, a region served by an interconnected set of internet service providers would define a region. A region served by different internet service providers could define a different region.

The replicating at least a portion of the database can be performed via a batch file operation performed on a scheduled basis or on a transactional basis. If performed on a transactional basis, the healthcare data being replicated can be according to a secure sockets layer (SSL) protocol to encrypt the healthcare data.

The replicated portion of the central server can be configured to be retrievable from a client machine via the unique identifier, the unique identifier enabling the client machine to download a reduced database of healthcare data. In an embodiment, the reduced database of healthcare data is configured to include one or more of allergy data, laboratory reports, medications, current condition data and current healthcare issue data.

In one embodiment, the central server is one of a plurality of regional servers connecting a plurality of communities, the replicated portion of the database of the central server being in at least one of the plurality of regional servers located outside the service area of the at least one electrical power grid providing service to the central server. In an embodiment, one or more of the plurality of regional servers is configured to hold replicated data from other regional servers, either as a complete replication or as a partial replication. For example, the data can be reduced for purposes of emergency use only. Thus, in the case of a natural disaster, for example, one of the regional servers in combination with other regional servers surrounding a given region will have all healthcare data necessary to treat patients affected by a natural disaster should an electrical grid covering a region affected be out of service. If more than one electrical grid covering more than one region is out of service, such as for example a widespread outage, in one embodiment, the regional servers are distributed as a random function among servers that are a distance from any region. The distance can be determined according to a likelihood of disaster metric.

Block 530 provides for replicating the at least a portion of the database in a second central server connected to a second community of independent sources of healthcare data for one or more patients, the second central server including a second database of healthcare data for a second plurality of patients. In an embodiment, the second central server is networked to at least two servers in the second community of independent sources of healthcare data, one or more of the two servers in the second community of independent sources of healthcare data being independent of a replicated database of the central server. In an embodiment, the replicated portion of the central server can be made available from a client machine connected through a dial-up connection, the replicated portion available via a dial-up connection being a compressed version of the healthcare data.

Block 540 provides for enabling access by a client machine to the replicated portion of the database via a unique identifier, the client machine accessing one or more patient records via the unique identifier, the patient records including healthcare data from one or more independent sources of the healthcare data.

In one embodiment, computer system 100 is configured to be connected via a network connection to a community of independent sources of a plurality of healthcare data records. In an embodiment, computer system 100 includes a data store coupled to the processor. The data store can be configured to organize in a database the plurality of healthcare data records from the community of independent sources, the plurality of healthcare data records for one or more patients. Computer system 100 can further be configured with a transceiver coupled to the processor. The transceiver can be configured to transmit a replica of at least a portion of the database to at least two servers networked to the computer system, according to methods described herein. The at least two servers can be determined as a function of coverage of at least one electrical power grid providing service to the computer system to prevent an outage from the at least one electrical power grid from interrupting access to the database.

### Tagger Tool

The Tagger Tool is a program that supports populating the Universal Patient Record (UPR) from various forms of transcribed physician Encounters. It takes in well-formed electronic versions of those Encounters, scans them for proper format against a set of externally defined rules, adds the proper XML tags, and links them to items in the Patient Database. The Tagger Tool returns the Encounter document to the tagging specialist quality assurance that sends it for entry into the Patient Database.

Incoming Encounter documents are well formed; that is, they adhere to the input requirements and syntax recognized by the Tagger Tool. These input requirements are identified in the Data Entry Plan.

Tagging is done from a set of externally described rules maintained in a separate table known as the Rules Table. These Rules are maintained in the Data Entry Plan and are documented under strict version control.

The Tagger Tool is a software program that is a combination of rules-based expert system technology and natural language artificial intelligence processing.

The Tagger Tool functions as a stand-alone process, under version control, that accepts Encounter documents in a serially asynchronous mode, performs various tasks against the information contained in those Encounters and returns them to the system. The Tagger Tool monitors a directory looking for input of Encounters

Upon receipt of an Encounter, the Tagger Tool processes the input file and returns the output. It does not store any documents other than during the time it is acting upon them. All documents moved to and from the Tagger Tool can be encrypted and adhere to a minimum of TripleDES/DES+ levels of encryption.

Once the Tagger Tool completes the required automated tagging and linking activity, it returns the Encounter for entry into the Patient Database.

Internal measures to ensure that the Tagger tool is functional include completeness, i.e., the ability of the Tagger Tool to tag and link in such a manner that it exceeds the productivity of the tagging specialist when performing in a manual mode; and cycle time, i.e., the total time from when a change is requested until the change is made, tested and integrated into the production tool.

### Tagging Process

The tagging process is the process wherein traditional transcribed healthcare encounters are converted into the patient database utilizing XML tags via automation by the system in conjunction with manual coding by staff to populate the electronic healthcare record.

An electronic encounter report from submitting physicians in various formats can be converted to Word or another appropriate program. Examples of programs that can be converted include: Provox™; e-MD™; and Meditech™.

According to an embodiment of a method for a specialist first receives electronic encounter via Patient Information Management System (PIMS). Next, files are queued according to parameters. Files are then processed FIFO (first in-first out). In one embodiment, a tagging specialist may not skip files without authorization from supervisor. Next, a tagging specialist runs an encounter through the automated tagger. The encounter is then checked for accuracy and errors corrected. Next, the encounter is checked for omissions. The tagging specialist then tags pertinent healthcare information utilizing the appropriate XML tags. In one embodiment, standard XML tags utilizing InstantText are used. In one embodiment, manual tags not included in standards are used. The tagging specialist uses a prescribed method for creating, naming, and saving documents.

If a file contains a deficiency, a tagging specialist flags (notation, highlighting, etc.) for QA. If file does not contain deficiency, the tagging specialist saves the file at completion of tagging. Next, the tagging specialist submits completed file to quality assurance via PIMS.

In one embodiment, the system requires that tagging be performed within a 24-hour turnaround time from the point of receipt.

Quality Assurance receives tagged encounter from a tagging specialist, reviews for tagging accuracy and corrects errors. Notation of any deficiency is sent to the tagging specialist, if appropriate.

If unable to correct deficiency, a tagged encounter is placed in ‘pending’ status and notification sent to submitting physician. Quality Assurance also submits completed files to Patient Database Process via PIMS.

The tagging process produces an accurately XML-tagged patient encounter to Patient Database Process wherein any and all pertinent and appropriate healthcare data is abstracted into the database accurately and efficiently.

In one embodiment, a tagging specialist can ensure efficient population of the database following data tagging/abstraction procedures utilizing encounters submitted by physicians in electronic form. This can be accomplished utilizing experienced healthcare transcriptionists who have been trained.

Protection of Personal Health Information

UPRs can be configured to follow state and federal law to protect the privacy of health information that may identify specific individuals. This health information may include mental health, developmental disability and/or substance abuse services, payment for those health care services, or other health care operations. The system can be configured to possess HIPAA-compliant security measures to protect the healthcare data contained within it. Electronic files of original encounters submitted by physicians can be stored in a secondary backup as a contingency plan for disaster recovery: Regular backup and a vendor plan that includes disaster recovery. Per HIPAA regulations, all received patient information can be retained for an indefinite period of time in a secure electronic format.

Encounters can be submitted in an electronic, nonproprietary format by the physician to a repository and received via a PIMS in MS Word-compatible format, or any other format. A mechanism for automated parsing of pertinent healthcare data in one embodiment uses XML tags in an accurate manner. An automated tagger can be triggered to run automatically before viewing encounter on screen, alternatively, automated tagger can be initiated manually upon pulling document up on screen.

Tagging can be configured such that it is accomplished without a tagging specialist having to take hands from the keyboard, i.e., to use the mouse, scroll from screen to screen, etc. An interface can be provided between the PIMS and the database: tagged encounters can be transmitted by a tagger operator via the PIMS to the Patient Database Process. The patient information management system (PIMS) can have the capability to securely maneuver encounters within it.

### Disaster Recovery Plan

Disaster Recovery is the process whereby captured patient data and UPRs are committed to custodial care, are copied and stored in multiple sets of media so that at least one copy of the data is protected from destruction by either physical or natural means. Disaster Recovery can be provided by an outside vendor; possibly the hosting partner. Disaster Recovery requires the use of multiple, redundant types of media. Disaster Recovery data can be configured such that it is not to be allowed to share data resources.

As the custodian of demographic data and Protected Health Information for members of the service, such data is preserved in such a manner that it can be reconstructed pursuant to any disaster which would destroy such records in either the health care provider's facilities or those of the hosting vendor.

All data stored in off-line media can be encrypted while in storage and re-encrypted if transportation is required. Encryption can be at a DOD-level for HIPAA requirements.

Periodic audits can be performed against the database by comparing a record retrieved from the vendor with records selected at random from health care provider locations. The vendor can provide a methodology for testing the Business Continuity aspects of their Disaster Recovery plans. The vendor can also provide a methodology for testing their Disaster Recovery plans. Although there is no real test for Disaster Recovery except during an actual disaster, various portions of the plan can be exercised or simulated.

### Patient Database Plan

The Patient Database is an electronic repository that contains the longitudinal UPR belonging to patients who participate in the network. The UPR begins when patients become members of the service and contains information relevant to their Comprehensive Healthcare History, physician encounters, family histories, images and laboratory results. A process provides updated information to this repository, which is then displayable by personnel having the proper credentials and authority.

A local copy of the Patient Database can reside in the health care provider's point of service. The local copy of the Patient Database can keep the set of most recently active patients. Storage requirements for the local copy of the Patient Database can be determined during the Assessment Process.

If a patient UPR is not found in the local copy of the Patient Database when requested by the health care provider or staff member, a record retrieval request can be made to the hosting site and a copy of the record will be brought into the local database for processing and/or maintenance. Changes made to the local copy of the Patient Database can be replicated to the hosting site database on a regularly scheduled basis. In one embodiment, no records are ever deleted from the host repository. Records may, however, be moved to non-volatile storage in the interest of system response.

Records can be stored in two parts: 1) traditional field/record/file relationships generated from a Relational Database Model and 2) XML tags associated with each field. These two parts can be joined upon retrieval and before transport of the record occurs.

The Patient Database can be configured to support the assembly and storage of a comprehensive longitudinal health care record based on the ID of a patient. Access can be physically and electronically secure and the records can be protected via a combination of confidentiality, security and privacy constraints. Journaling can provide both an audit trail to each element within the database and a recording facility for all changes made, including a record of when and by whom such changes were made.

All information contained in the Patient Database can be encrypted with a database level of encryption while it is stored in the data repository. Data records selected for transport can be encrypted at a DOD-level of encryption during transport.

Accuracy and integrity of the information contained in the Patient Database can be maintained through the use of periodic checks and audits.

Internal measures can be determined by balancing the results obtained through applying compression algorithms against cycle time measurements. The balancing ensures optimum storage/performance characteristics of the database; both local and hosted. In one embodiment, a reserve storage capacity of at least 25% can be required to be maintained by the hosting partner.

External measures can include cycle time, the time from request to retrieval of a given patient record. External measures can be optimized, regardless of whether it is from the local copy of the hosting repository.

### Connectivity Plan

In one embodiment, the community of independent sources of healthcare data can be connected by data interchange between a server, such as a client server located in a provider's office (point of service) and a host database in a central server.

In one embodiment, there is no requirement for data interchange with either the host database in the central server or a provider's practice management system. Note also that either or both of these can be requirements in other embodiments.

Traffic forecast volumes and patient record volumes can be acquired to determine ISP bandwidth and hard drive storage requirements. Client servers can be installed in the provider's point of service location(s). In one embodiment, two servers reside in each point of service, connected in a dual/redundant configuration supported by error detection and fast failover capability.

Client servers installed in each facility can be required to have a secure broadband connection to the internet. In one embodiment, client server failure results in an automatic operational transfer from the failing unit to a known good server and a ‘request for service’ message sent to an identified repository for appropriate action.

Daily activity in the practice can use the active server with replication taking place during hours of non-operation or, in the case of 24-hour operation, at a time of least-required activity. Client servers can connect to the provider's existing network through a single CAT5 connection and exercise an application running a graphical user interface set through a desktop icon that invokes a remote desktop application such as the Microsoft Remote Desktop™.

The client servers located in each provider's location can be configured such that they are sufficiently large enough to contain the complete UPRs for all patients who have ever frequented the provider for healthcare services. It is a common practice today for physicians to move some of their records into a storage facility. Thus, in one embodiment, the client servers maintain a local copy of the most-recently-seen set of patients. The size of this most-recently-seen set of patients may vary from provider to provider. The hosting site can be configured to house UPRs for the remaining patients. If a patient is not known at the provider's location, the client server requests UPRs from the hosting site that downloads the records to the client server when healthcare services are required for those patients. In one embodiment, a provider's requirements for the delay/latency period associated with this retrieval can be taken into account.

The use of dual client servers with redundancy and fast-failover capability ensures that providers have access to the UPRs when needed to provide health care services. All document and data interchanges are encrypted at the level of each transaction and can adhere to a minimum of Triple DES/DES+ levels of encryption.

Quality Assurance can be maintained by a set of automated, periodic checkpoints established by the error detection and redundancy software installed on each client server. When errors are detected by the software, an appropriate error message can be automatically routed to a queue designated to accumulate automated hardware errors. Appropriate logs can be attached to the automated message which can identify the failing devices and specific errors.

The selected service provider can be required to install broadband IP connectivity for routing documents and service/support requirements. Client Servers of sufficient throughput to maintain expected volumes can be required with antivirus and firewall protection.

To determine internal measures, Mean Time Between Failures (MTBF) for each client server and Mean Time To Repair (MTTR) for each client server can be determined. However, the MTTR measurement may be waived in the event client servers are scrapped rather than repaired. Also the Number of Repair Actions (RA's) for each client server, Duration of Repair Action (DRA) for each client server can be measured.

External measures can include the Number of Repair Actions for each provider, Response Time—Time for field technician to respond if on-site service is required; and Downtime—Time provider is without access to the client server(s). As appreciated by one of skill in the art, the method(s) to obtain downtime measurement as well as the measurement itself can take various forms.

In one embodiment, a disaster recovery plan is in place. In one disaster plan, a hosting operation can be housed in a secure state-of-the-art Tier 1 data center, with redundant Internet connections, virtually unlimited capacity, multiple levels of redundant electrical power, and 24/7 operators on staff. A data center can include high-capacity feeds to five or more backbone providers (such as AOL®, ATT®, Sprint®, UUNet®, Cable & Wireless), redundant power feeds from separate substations, emergency battery and generator power, secure data center with 24 hour guard and bio-metric access control, facility constructed specifically as a high-availability high-capacity data center, and high-speed high-capacity robotic tape backup system.

In one embodiment, an entity monitors the operating environment of dedicated servers and responds to outages as soon as possible using at least a 100 MB switched network. In one embodiment, each 4-hour backup replaces the prior day's backup except for the midnight backup, which is kept for 1 week. Additional weekly and monthly backups are also performed. The weekly backup is rotated every 3 weeks. The monthly backups are

13. The computer program product of claim 11 wherein the signal bearing medium comprises:

a transmission medium.

14. A computer system connected via a network connection to a community of independent sources of healthcare data, the computer system comprising:

a processor;

a memory coupled to the processor; and

a data store coupled to the processor, the data store configured to organize in a database the healthcare data from the community of independent sources, the database coded to enable on-the-fly transmission of the healthcare data to one or more healthcare service providers outside the community of independent sources; and

a transceiver coupled to the processor, the transceiver configured to transmit a report based on the healthcare data in the database, the healthcare data including one or more updates from one or more of the independent sources to enable one or more healthcare providers, including rarely-used healthcare providers, to receive current data concerning a plurality of patients, the current data including demographic data on the plurality of patients. kept indefinitely. Also, a weekly copy of the backup is stored off-site and rotated every 3 weeks.

For the purposes of this example, two types of recoveries will be described. The first being the crash of a single server and the second scenario is the complete failure of the data center.

In the single-server crash scenario it is assumed that a single server. The first step is to work with the data center to determine the extent of the damage and the amount of time required to get the server backup and running. A decision is then made whether to temporarily restore to a different server on the network until the effected server is restored. Custom settings and data can be restored from the most current backup available. Upon repair of the effected server, applications and data can be restored and updated with the latest configuration and data.

In the remote scenario of complete data center failure, a decision can be made whether to use a location some distance away from the scene of the disaster where computing and networking capabilities can be temporarily restored until the primary site is ready. The first step in the recovery process can be to procure the necessary hardware to recreate the hosted environment. The next step can be to install and configure the proper operating system. Custom settings and data can be restored from the most current backup available. Upon restoration of the data center each hosted customer along with their most current data and configuration can be migrated back to the data center.

The following outlines another embodiment of the present invention representing a technology installation plan for a call center including Voice over IP Virtual Contact Center (VoIP VCC).

### Graphical User Interface

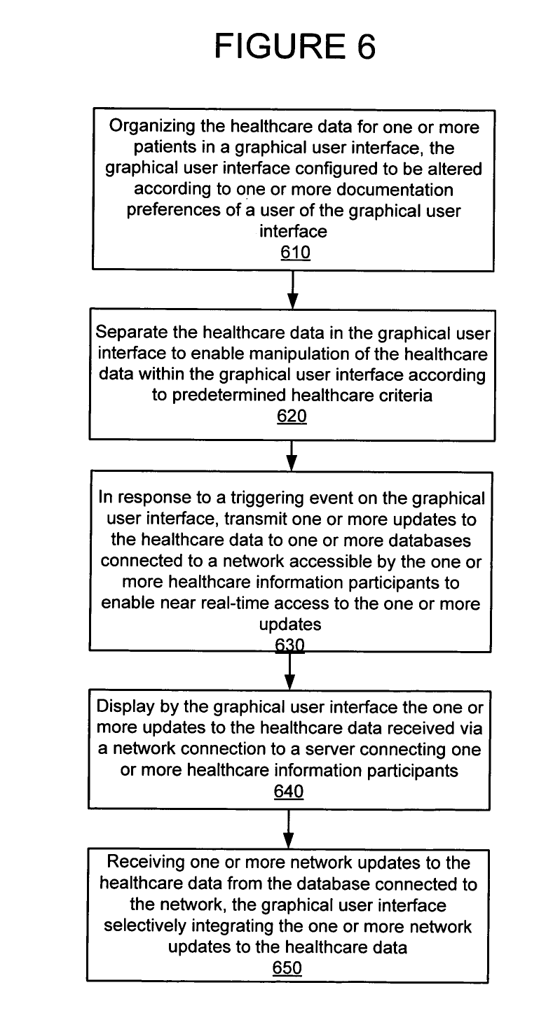

Referring now to FIG. 6, at least one embodiment is directed to a graphical user interface to implement user interactivity with the patient database.

More specifically, referring to FIG. 6, a method of operating a computer to display and manipulate healthcare data is illustrated. The method of operating a computer includes operating a graphical user interface configured according to embodiments herein. Block 610 provides for organizing the healthcare data for one or more patients in a graphical user interface, the graphical user interface configured to be altered according to one or more documentation preferences of a user of the graphical user interface. For example, documentation preferences of a user can include documentation preferences of a provider of healthcare services or another healthcare data provider.

Block 620 provides for separating the healthcare data in the graphical user interface to enable manipulation of the healthcare data within the graphical user interface according to predetermined healthcare-related criteria. For example, predetermined healthcare-related criteria can include healthcare-related criteria appropriate for a UPR or other healthcare-related criteria determined important as a function of the specialty of a physician or the like.

Block 630 provides for, in response to a triggering event on the graphical user interface, transmitting one or more updates to the healthcare data to a database connected to a network accessible by the one or more healthcare information participants to enable near real-time access to the one or more updates. More specifically, in an embodiment, the healthcare information participants include insurers, physicians, pharmacists, laboratories, hospitals and the like. Thus, if one healthcare information participant operating the graphical user interface uploads updates to a database, the database can provide near real-time access to those updates to other healthcare information participants. A triggering event on the graphical user interface can include a user specifically identifying a need to update the healthcare data or can be an event

Block 640 provides for displaying by the graphical user interface the one or more updates to the healthcare data received via a network connection to a server connecting one or more healthcare information participants. For example, the server updating the database can display updates provided by its own connection or can display updates provided by other healthcare information participants.

Block 650 provides for receiving one or more network updates to the healthcare data from the database connected to the network, the graphical user interface selectively integrating the one or more network updates to the healthcare data. For example, a client server located in a physician's office can selectively integrate updates according to its own requirements. For example, the requirements can include providing links combining the healthcare data provided by the one more healthcare information participants including one or more of insurance providers, laboratories, pharmacies, and specialists. The links can include one or more links to the healthcare data provided by one or more specialists, the information including one or more of physical therapist data, psychiatric data, chiropractic data, podiatrist data, ophthalmic data, doctor of osteopathy data, and non-primary care specialist data. In another embodiment, the links can include links to healthcare data concerning one or more of blood product data relevant to the patient, tissue donation information, durable power of attorney data, and resuscitation preferences of the patient.

The receiving one or more network updates to the healthcare data can be from the database connected to the network, the graphical user interface selectively integrating the one or more network updates to the healthcare data can include displaying the network updates in a location within the graphical user interface as a function of healthcare importance of the network updates. For example, demographic data can be important for new patients and be of top priority for updating. Also, in one embodiment, the graphical user interface displays one or more of the network updates prominently if the one or more network updates identify healthcare data affecting the ability of a health provider to treat a patient of the one or more patients.

The selectively integrating the one or more network updates to the healthcare data can include integrating demographic data included in the one or more network updates to enable each of the healthcare information participants to share the demographic data.

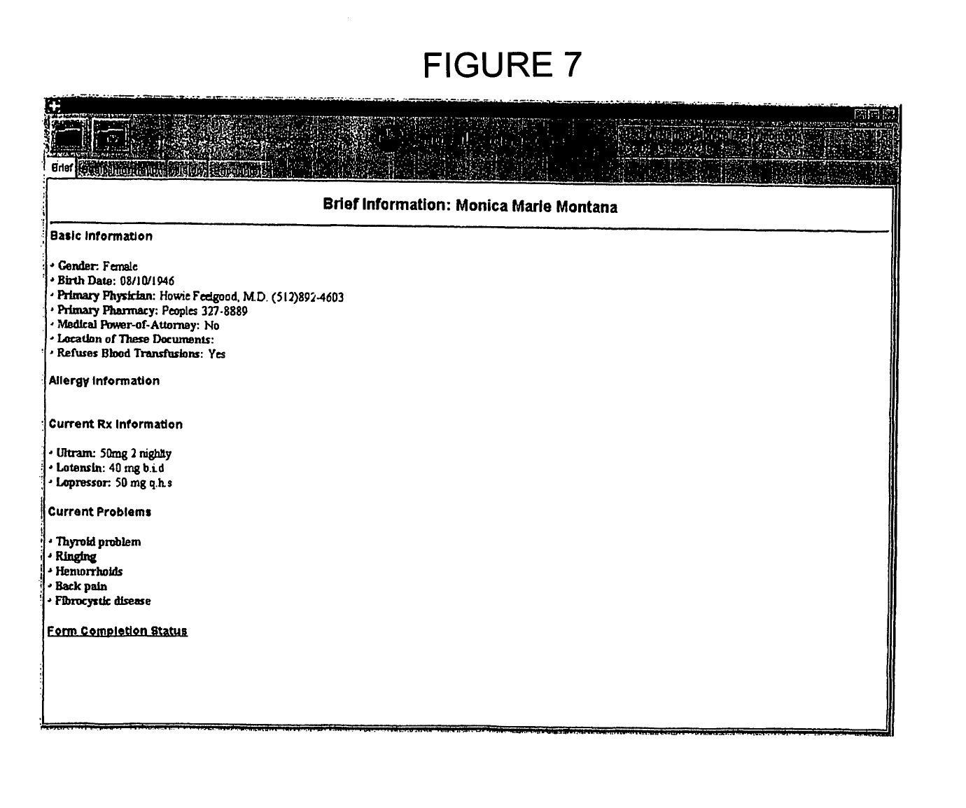

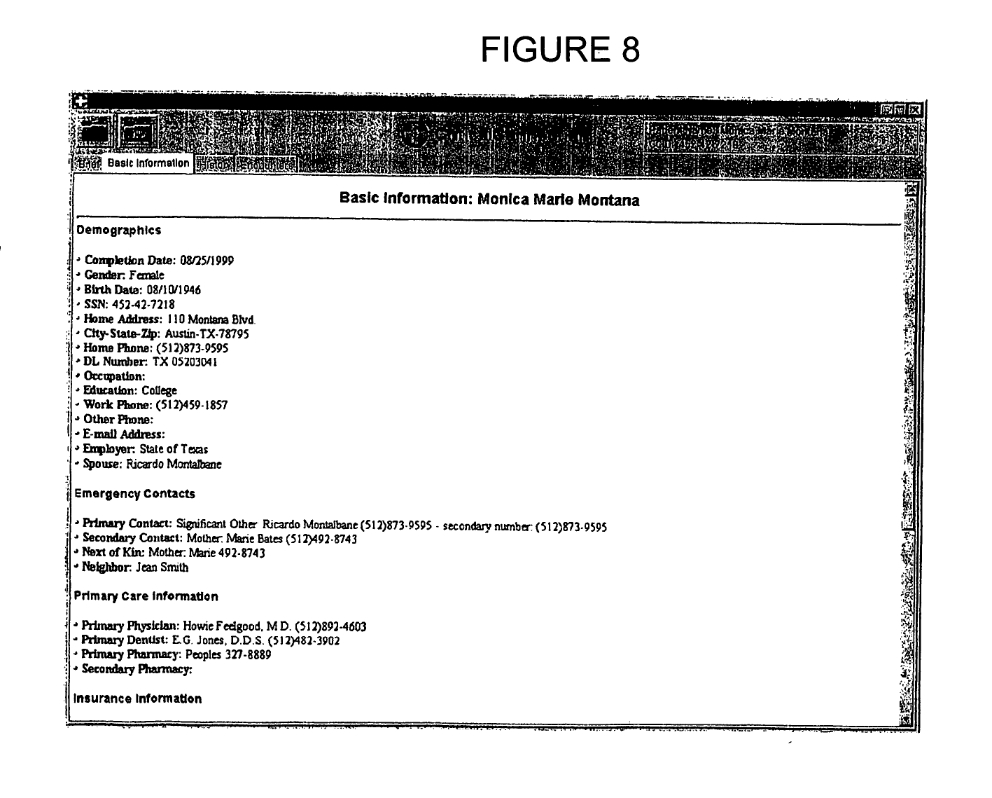

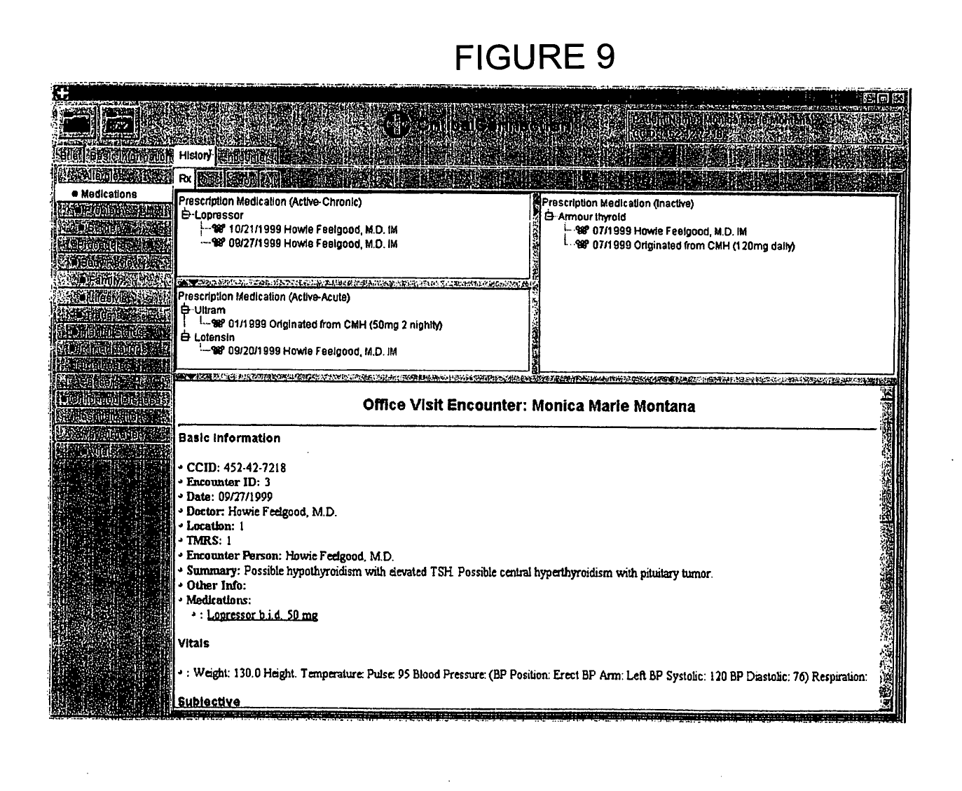

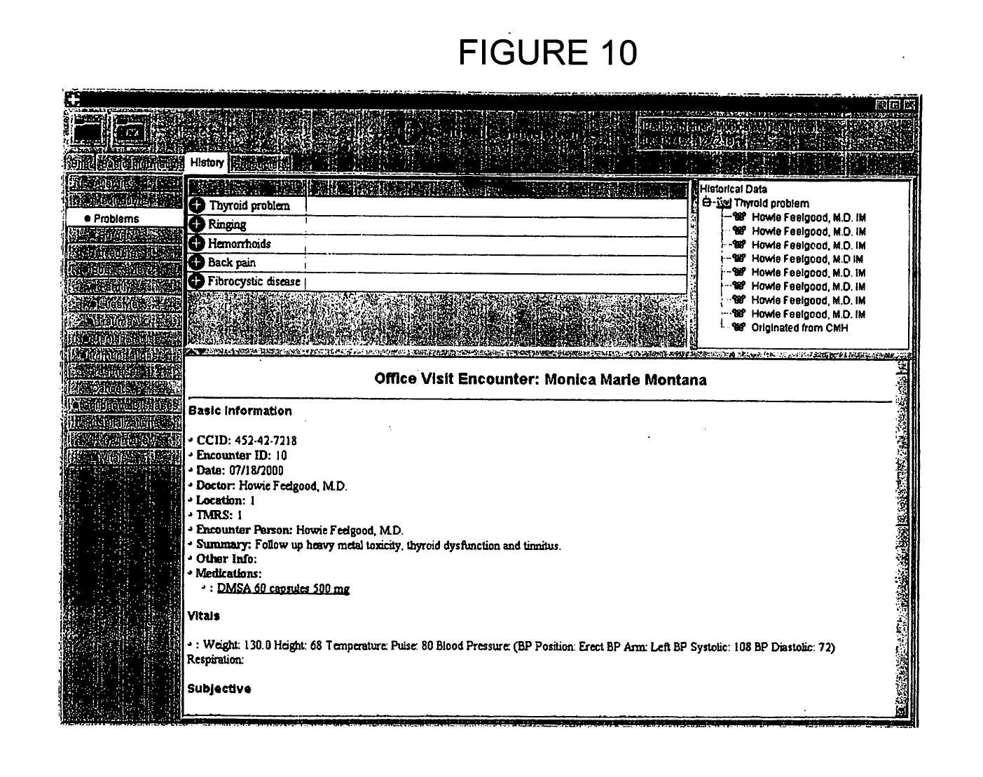

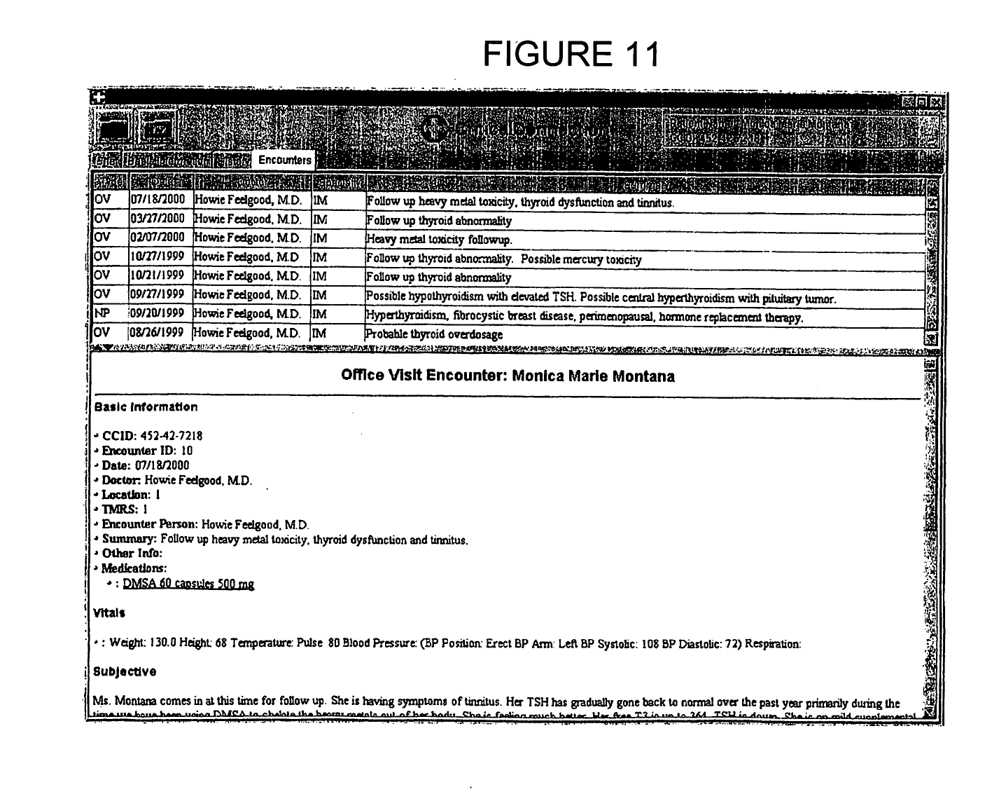

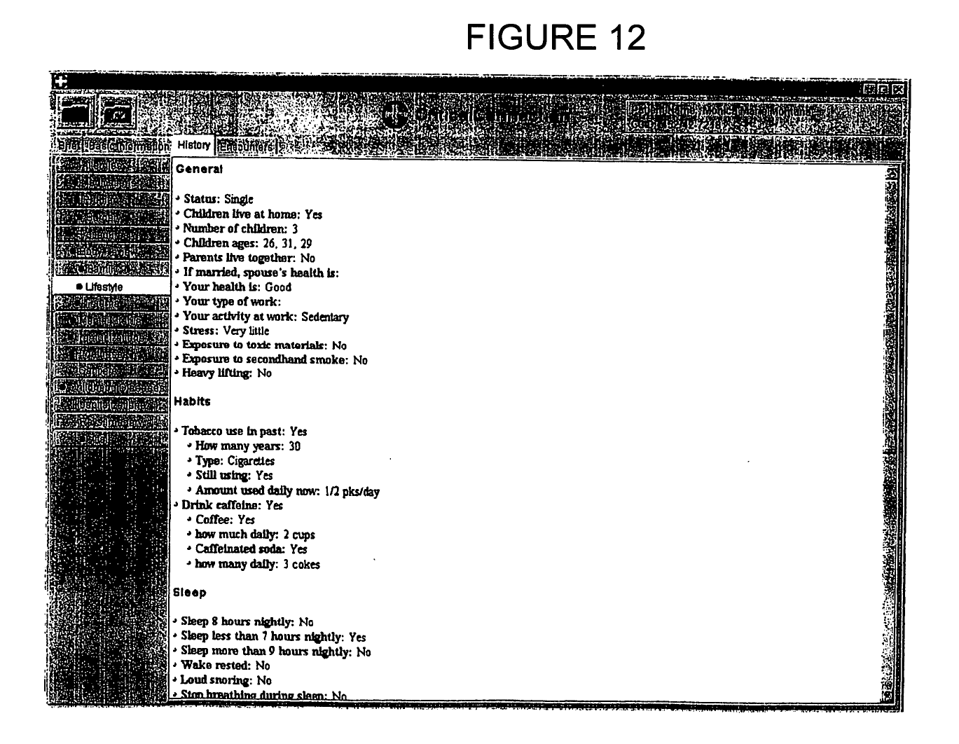

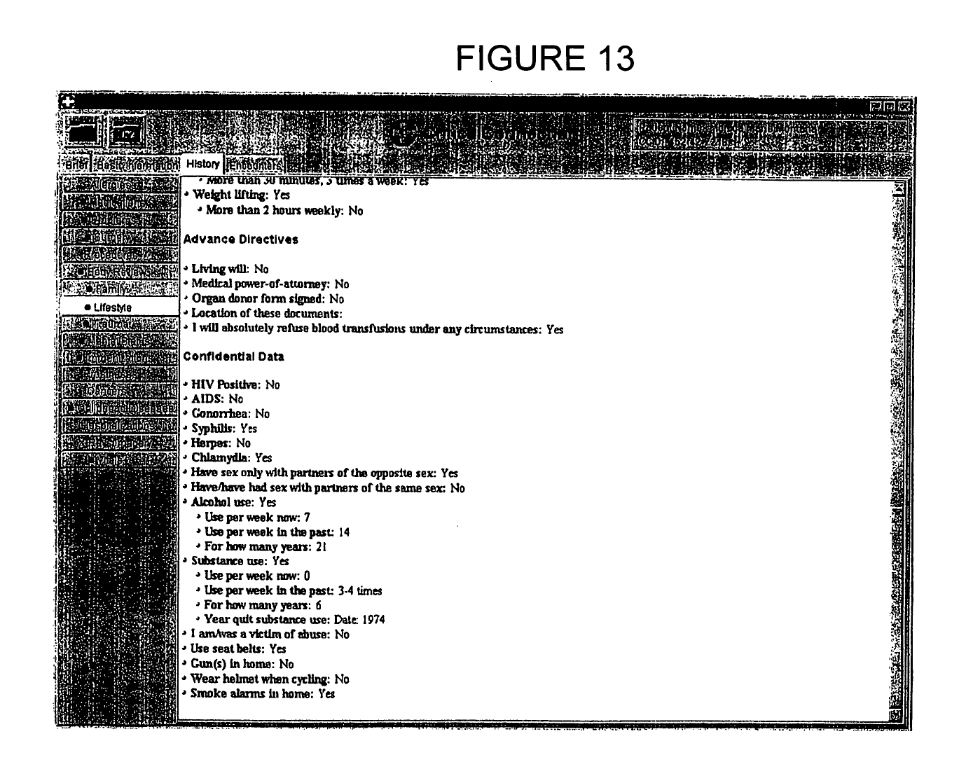

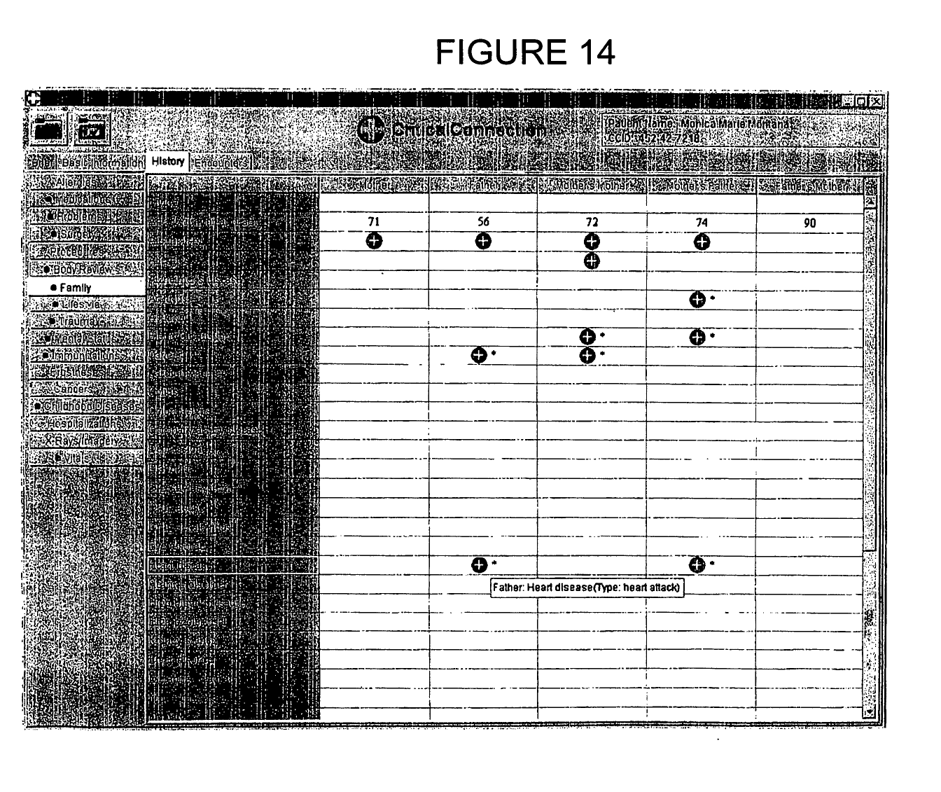

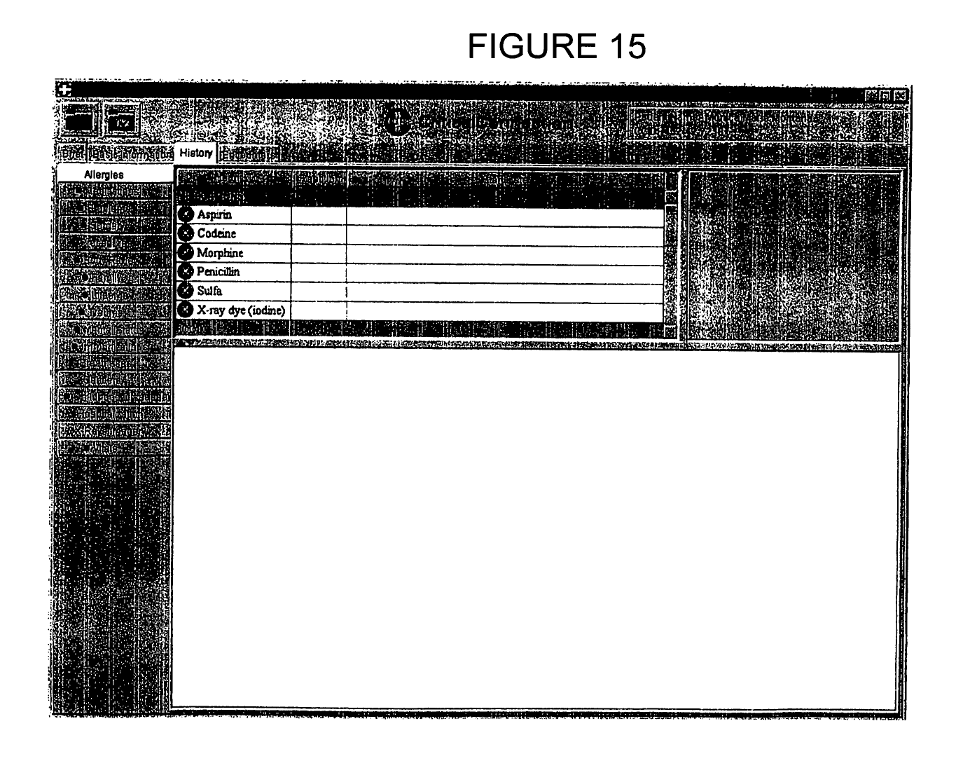

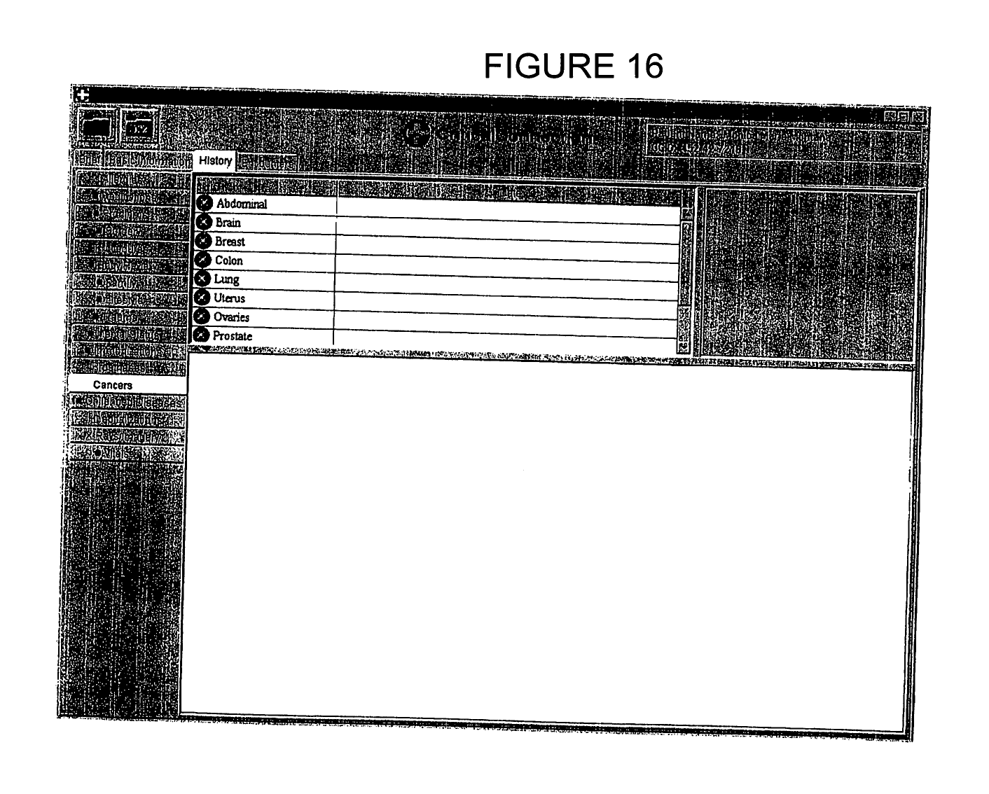

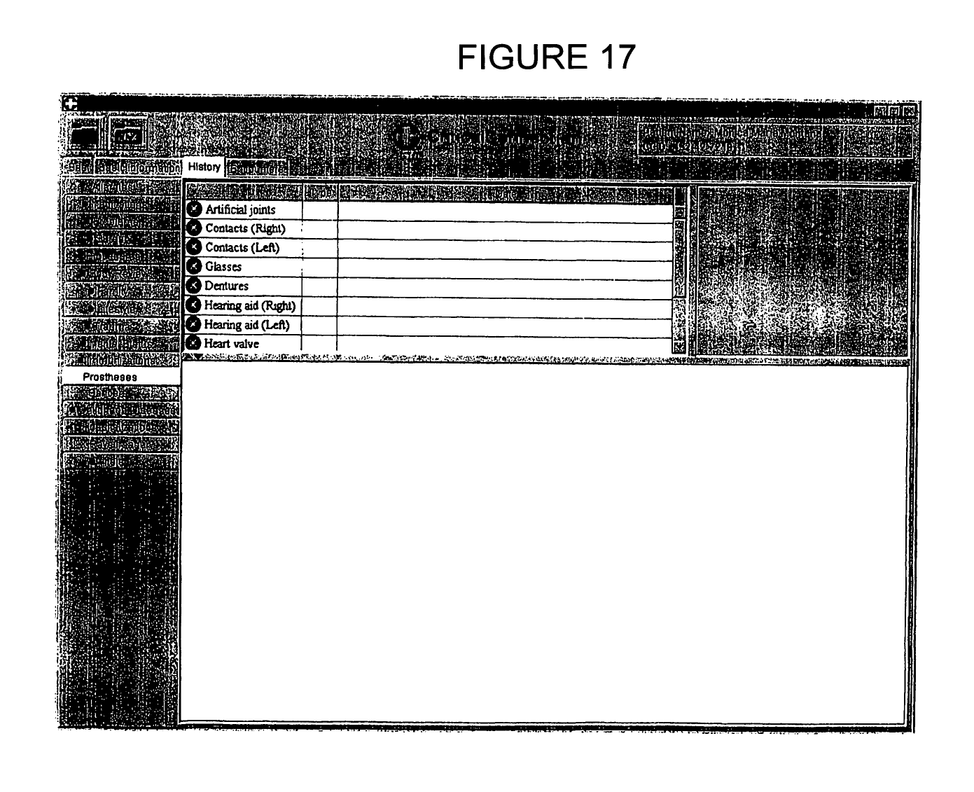

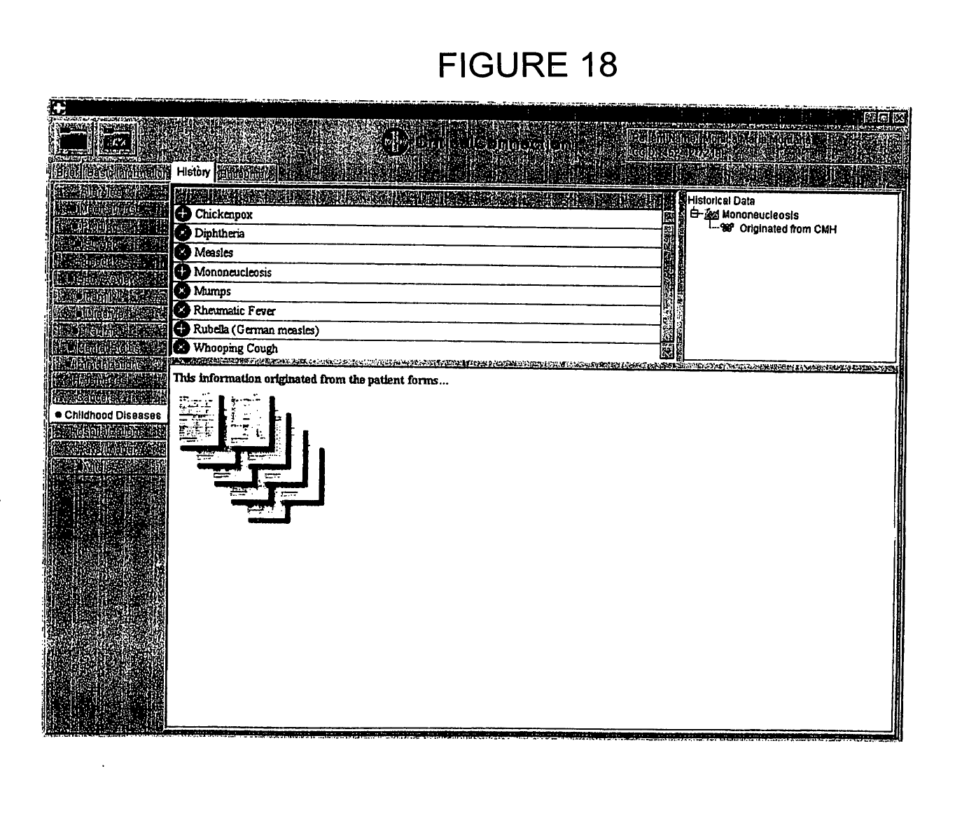

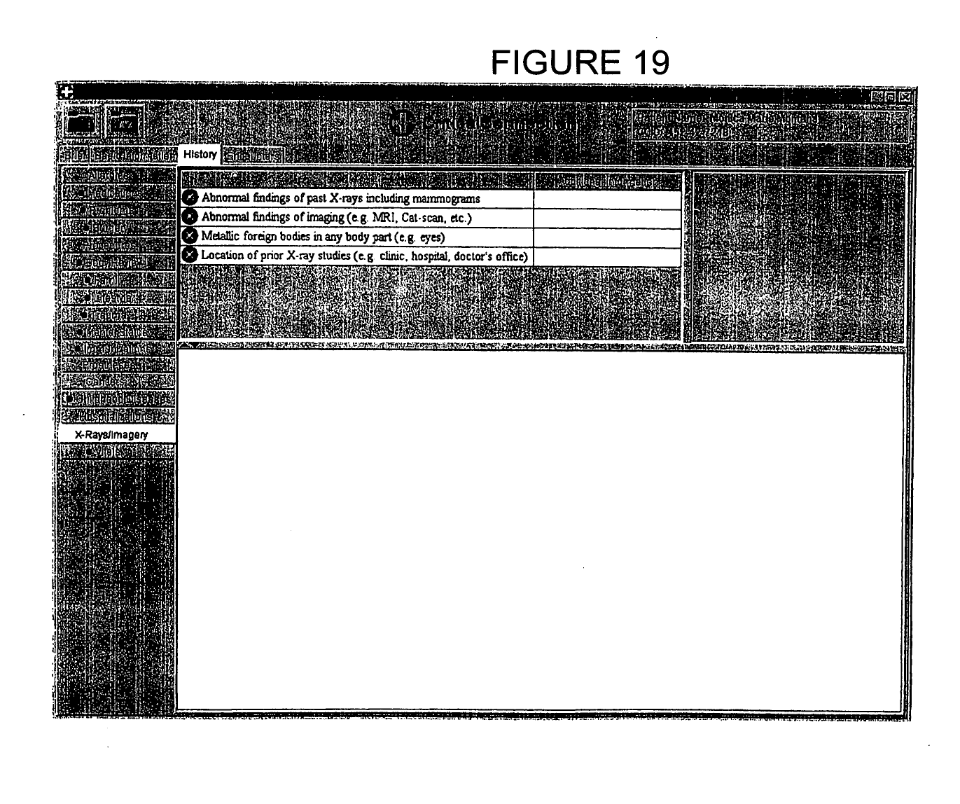

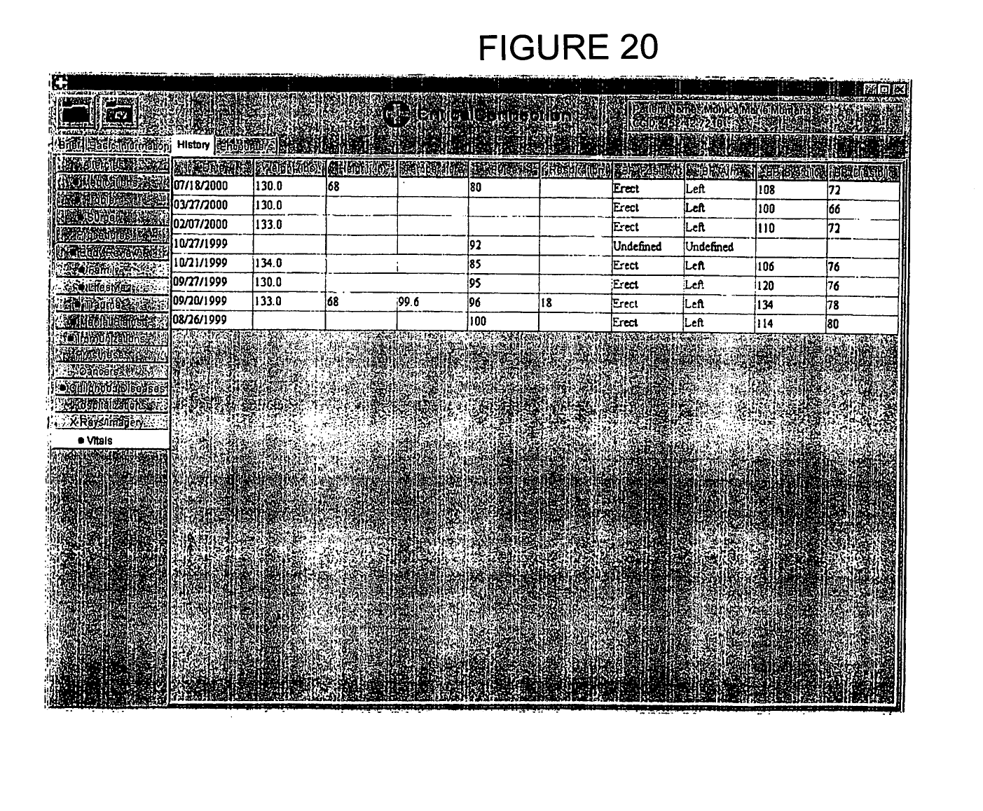

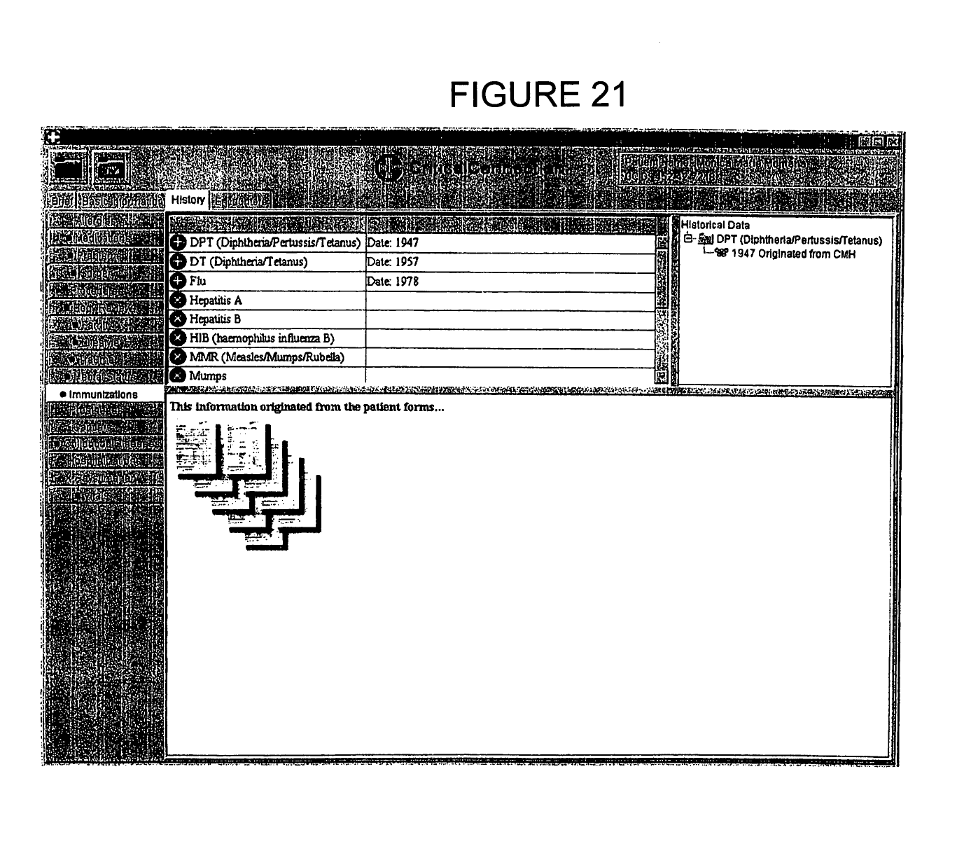

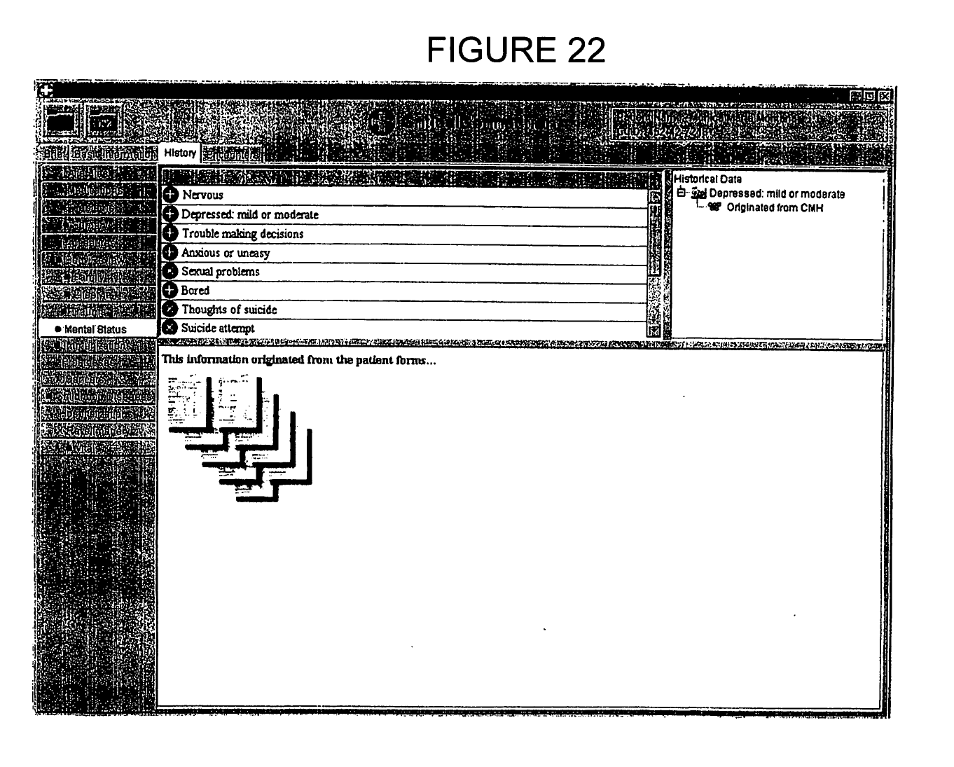

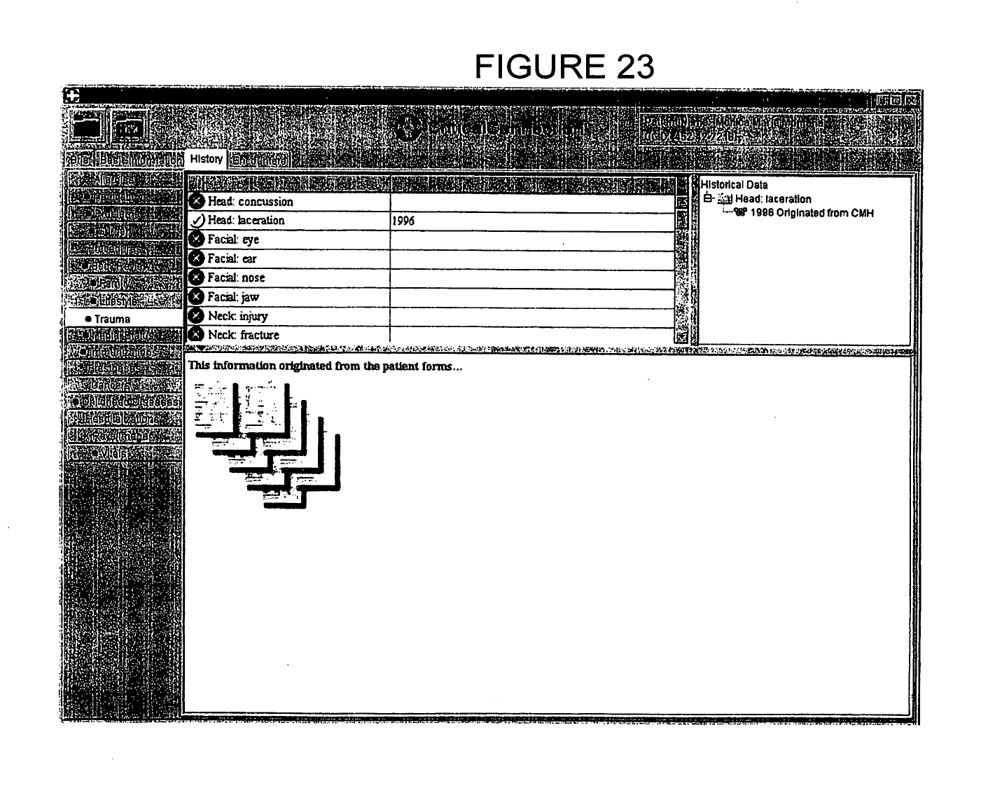

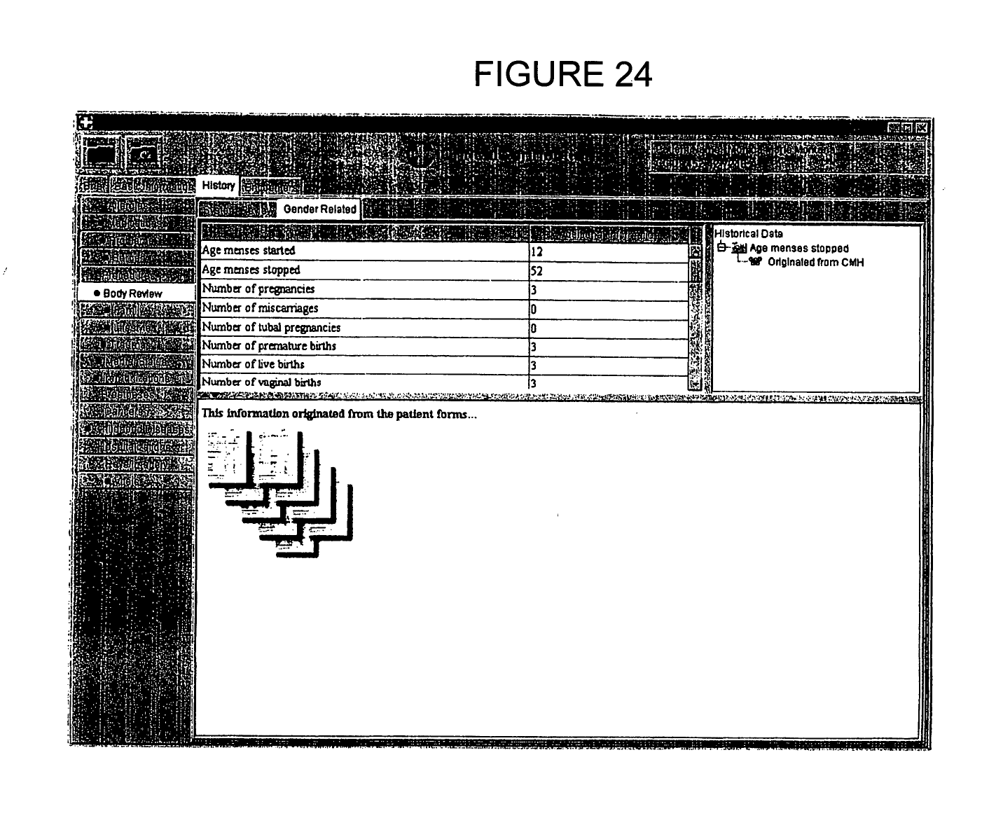

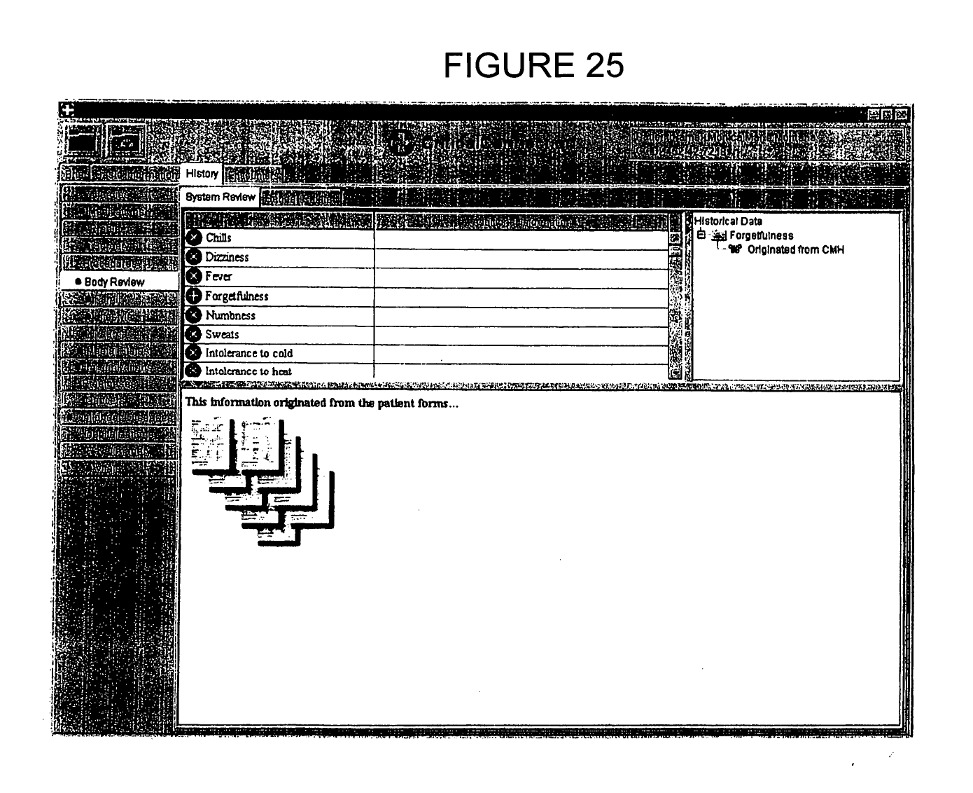

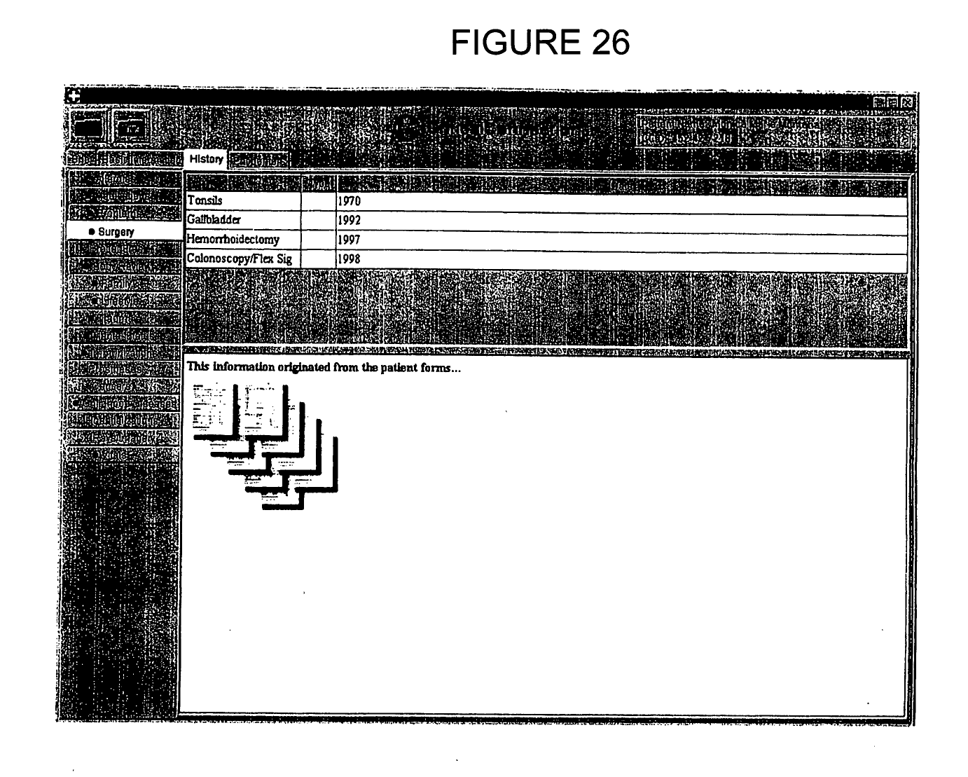

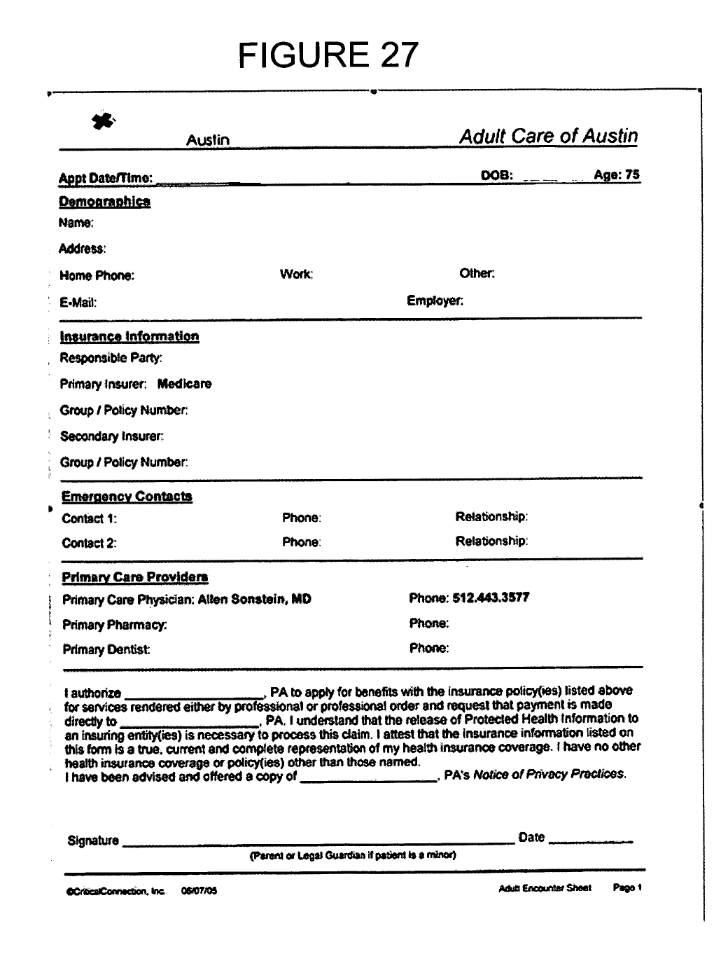

Referring now to FIGS. 7-26, an exemplary graphical user interface illustrates an embodiment for the organizing the healthcare data for one or more patients in the graphical user interface. The graphical user interface can be configured to be altered according to one or more documentation preferences of a user of the graphical user interface. FIG. 7 illustrates summary interface providing brief information of a patient of one or more patients included in a patient database, including one or more of gender, birth date, primary care physician, current medications, and current problems/issues with the one or more patients. In other embodiments, the summary can include vital data, not shown. FIG. 8 provides a more expansive interface with basic information including a demographic interface including demographic data of the one or more patients. The demographic data can include one or more network updates received from each of the one or more healthcare information participants via a network connection. FIG. 7-26 illustrate separating the healthcare data in the graphical user interface to enable manipulation of the healthcare data within the graphical user interface according to predetermined healthcare-related criteria. More particularly, FIGS. 9-25 illustrate how a graphical user interface would respond to clicking on one or more buttons shown on the left. Exemplary buttons include allergies, medications, problems, surgery, body review, trauma, mental status, immunizations, lifestyle, family, prostheses, cancers, childhood diseases, imagery/x-rays, and vitals. Each of the buttons can be physician directed according to an embodiment. FIG. 26 illustrates how encounters with a healthcare provider could be displayed. As shown a bifurcated page can be used to list each encounter in chronological order and an exemplary encounter summary in the lower portion of the page.

In one embodiment, the displaying by the graphical user interface the one or more updates to the healthcare data received via a network connection to a server connecting one or more healthcare information participants includes displaying an indication of whether the one or more patients has filled one or more prescriptions issued by any of the one or more healthcare information participants. More specifically, in the embodiment, if one of the healthcare data participants is a pharmacy, updates to the database can include which prescriptions have been filled, dates that the prescription were filled and the like. In one embodiment, those patients whose health depend on timing of drug taking or are at risk of abusing prescription drugs can be closely monitored. If pharmacies in a community are each healthcare data participants in the database, monitoring at-risk patients becomes efficient and near real time. For example, prescriptions that have been duplicated or otherwise refilled early or late can be flagged in the database so that a user viewing the graphical user interface will have access and be able to address further necessary actions with regard to a patient, if necessary.

In one embodiment, the displaying an indication of whether the one or more patients has filled one or more prescriptions issued by any of the one or more healthcare information participants includes displaying an indication of whether the one or more patients have received compatible care from the one or more healthcare information participants. For example, prescriptions can be written by physicians, practical nurses, and specialists treating different conditions. Typically, pharmacists can detect conflicting prescriptions if the prescriptions are filled at a same location or entity. According to an embodiment, the patient database can receive prescription information from a plurality of participating healthcare data participants including any pharmacy in the community and enable detection of conflicting prescriptions by any of the healthcare data participants.

In one embodiment, the providing a summary interface provides a link in the summary interface to enable a user of the graphical user interface to access further data regarding the one or more patients. Thus, according to the tagging procedure described above, a user can click or otherwise select a medically-determined link for further data. The graphical user interface, for example, could provide that any of the current problems or the “form completion status” shown in FIG. 7 is selectable to instantiate a different page from the graphical user interface. FIGS. 7-26 each display links, each of which can provide a link to an encounter interface identifying one or more encounters of a patient of the one or more patients, each encounter identifying one or more of the healthcare information participants, a date of encounter, and/or a summary.

In one embodiment, the providing a link includes links to a documentation plan for one or more governmental supported healthcare programs. Governmental supported healthcare plans can include Medicaid, Medicare, prescription programs and the like.

In one embodiment, the summary interface can include a link enabling preparation of a printable day sheet usable during a patient visit to one of the one or more healthcare information participants, the printable encounter providing the healthcare provider with current data received via one or more network updates received from the database. Referring to FIG. 26, a sample day sheet is illustrated. A day sheet can be populated using latest network updates and provide for inserting additional data.

The use of the terms “a” and “an” and “the” and similar referents in the context of describing embodiments of the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

We claim:

1. A method for disseminating healthcare data in a database, the method comprising:
storing the healthcare data in the database located in a central server connected to a community of independent sources of the healthcare data for a plurality of patients;
incorporating one or more updates to the healthcare data in the database from one or more of the independent sources to enable one or more healthcare providers, including rarely-used healthcare providers, to receive current data concerning the plurality of patients, the current data including demographic data on the plurality of patients; and
coding the healthcare data in the database to enable on-the-fly transmission of the healthcare data to one or more healthcare service providers outside the community of independent sources.

2. The method of claim 1 wherein the incorporating one or more updates to the healthcare data in the database from one or more of the independent sources to enable one or more healthcare providers, including rarely-used healthcare providers, to receive current data concerning the plurality of patients, the current data including demographic data on the plurality of patients includes:
receiving the one or more updates to the healthcare data via a natural language integration of transcribed updates to the healthcare data; and
substantially automatically parsing the transcribed updates to the healthcare data to provide tagging of the healthcare data according to physician-directed criteria.

3. The method of claim 2 wherein the receiving the one or more updates to the healthcare data via a natural language integration of transcribed updates to the healthcare data includes:
receiving oral healthcare data from the one or more healthcare providers, the oral data received at the central server for transcribing via natural language processing to determine which of the healthcare data should be tagged according to the physician-directed criteria.

4. The method of claim 1 wherein the central server is one of a plurality of regional servers connecting a plurality of communities of independent sources of healthcare data.

5. The method of claim 4 wherein the incorporating one or more updates to the healthcare data in the database from one or more of the independent sources to enable one or more healthcare providers, including rarely-used healthcare providers, to receive current data concerning the plurality of patients, the current data including demographic data on the plurality of patients includes:
enabling one of the one or more rarely-used healthcare providers to receive the one or more updates to the healthcare data via any of the plurality of regional servers.

6. The method of claim 1 wherein the coding the healthcare data in the database to enable on-the-fly transmission of the healthcare data to one or more healthcare service providers outside the community of independent sources includes:
providing access to the healthcare data in the database to enable the on-the-fly transmission via a secure dialogue with the central server using a unique identifier, the unique identifier instigating the secure dialogue.

7. The method of claim 6 wherein the healthcare data available for on-the-fly transmission is a reduced database of healthcare data, the reduced database of healthcare data including one or more of the demographic data, allergy data, laboratory reports, medications, current condition data and current healthcare issue data.

8. The method of claim 6 wherein the on-the-fly transmission is received as a report from the central server, the report based on a universal patient record stored in the database.

9. The method of claim 8 wherein the report is in the form of a written and/or oral transmission from the central server to a predetermined location, the predetermined location being one or more of a client machine, a facsimile machine, and a telephone.

10. The method of claim 8 wherein the universal patient record is configured as an electronic data interface populated with tagged healthcare data, the universal patient record configured with tagged healthcare data to enable linking of healthcare data between a summary of patient information, a listing of current medications, the demographic data, vital data, insurance data, pharmacy data, identification of a primary care physician and current healthcare issues.

11. A computer program product comprising:
a signal bearing medium bearing;
one or more instructions for storing the healthcare data in the database located in a central server connected to a community of independent sources of the healthcare data for a plurality of patients;
one or more instructions for incorporating one or more updates to the healthcare data in the database from one or more of the independent sources to enable one or more healthcare providers, including rarely-used healthcare providers, to receive current data concerning the plurality of patients, the current data including demographic data on the plurality of patients; and
one or more instructions for coding the healthcare data in the database to enable on-the-fly transmission of the healthcare data to one or more healthcare service providers outside the community of independent sources; and

12. The computer program product of claim 11 wherein the signal bearing medium comprises:
a recordable medium.

13. The computer program product of claim 11 wherein the signal bearing medium comprises:
a transmission medium.

14. A computer system connected via a network connection to a community of independent sources of healthcare data, the computer system comprising:
a processor;
a memory coupled to the processor; and
a data store coupled to the processor, the data store configured to organize in a database the healthcare data from the community of independent sources, the database coded to enable on-the-fly transmission of the healthcare data to one or more healthcare service providers outside the community of independent sources; and
a transceiver coupled to the processor, the transceiver configured to transmit a report based on the healthcare data in the database, the healthcare data including one or more updates from one or more of the independent sources to enable one or more healthcare providers, including rarely-used healthcare providers, to receive current data concerning a plurality of patients, the current data including demographic data on the plurality of patients.
